(19) United States
(12) Patent Application Publication
(10) Pub. No.: US 2020/0165122 A1
(43) Pub. Date: May 28, 2020

(54) METHOD FOR PRODUCING A TEXTILE COMPOSITE MATERIAL AND TEXTILE COMPOSITE MATERIAL PRODUCED ACCORDING TO SAID METHOD

(71) Applicant: k & r Textil GmbH & Co. KG, Mönchengladbach (DE)

(72) Inventor: Oliver SALZMANN, Willich (DE)

(73) Assignee: k & r Textil GmbH & Co. KG, Mönchengladbach (DE)

(21) Appl. No.: 16/087,754

(22) PCT Filed: Apr. 19, 2016
(86) PCT No.: PCT/EP2016/058644

§ 371 Date: Sep. 24, 2018

(30) Foreign Application Priority Data
Mar. 23, 2016 (DE) 102016003418.1
Mar. 24, 2016 (DE) 102016003494.7
Apr. 8, 2016 (DE) 102016106446.7

(51) Int. Cl. B68G 7/052; B32B 5/02; B32B 5/18; B32B 5/24; B32B 7/12

(52) U.S. Cl. CPC B68G 7/052; B32B 5/022; B32B 5/024; B32B 5/026; B32B 5/18; B32B 5/245; B32B 2307/30; B32B 2266/025; B32B 2266/0278; B32B 2262/0276; B32B 2266/0292; B32B 2479/00; B32B 2601/00; B32B 7/12

(57) ABSTRACT

The invention relates to a method for producing a textile composite material with shrink properties, in particular heat shrink properties, preferably in the form of a shrinkable, in particular heat-shrinkable textile upholstery and/or covering material, preferably for seating furniture, to the textile composite material obtained therefrom and to the uses thereof.

### CROSS-REFERENCES TO RELATED APPLICATIONS

This application is a National Stage filing of International Application PCT/EP 2016/058644, filed Apr. 19, 2016, “METHOD FOR PRODUCING A TEXTILE COMPOSITE MATERIAL AND TEXTILE COMPOSITE MATERIAL PRODUCED ACCORDING TO SAID METHOD” claiming priority to DE 10 2016 003 418.1 filed Mar. 23, 2016, DE 10 2016 003 494.7 filed Mar. 24, 2016, and to DE 10 2016 106 446.7 filed Apr. 8, 2016. The subject application claims priority to PCT/EP 2016/058644, to DE 10 2016 003 418.1, DE 10 2016 003 494.7, and to DE 10 2016 106 446.7 and incorporates all by reference herein, in their entirety.

### BACKGROUND OF THE INVENTION

The present invention relates to the technical field of functional textile materials, which in particular are used in the area of the furniture industry preferably for seating furniture, such as chairs or the like, for the formation of in particular support- or substructure-free coverings preferably for backrests or seat parts or the like. In this connection, the present invention relates in particular to the field of textile surface materials having shrink properties, in particular heat shrink properties.

In particular, the present invention relates to a method for producing a textile composite material having shrink properties, in particular heat shrink properties, preferably in the form of a shrinkable, in particular heat-shrinkable textile upholstery or covering material, preferably for seating furniture.

The present invention additionally relates to a textile composite material having shrink properties, in particular heat shrink properties as such, which can be obtained by the method according to the invention or a textile composite material having shrink properties, in particular heat shrink properties, which is preferably present in the form of a shrinkable, in particular heat-shrinkable textile upholstery or covering material, preferably for seating furniture. In this context, the present invention also relates to a (heat-) shrunk textile composite material which can be obtained on the basis of the textile composite material having (heat) shrink properties according to the invention.

Furthermore, the present invention also relates to the use of the textile composite material according to the invention having shrink properties, in particular heat shrink properties to produce or provide a corresponding (heat-) shrunk textile composite material. In this context, the present invention also relates to a corresponding method for producing the (heat-) shrunk textile composite material according to the invention as such.

The present invention further relates to the use of the textile composite material according to the invention having (heat) shrink properties or of the (heat-) shrunk textile composite material according to the invention in the area of the furniture industry, automobile industry or the like and to produce furniture elements, in particular seating furniture elements, and the like.

Finally the present invention also relates to a method for producing furniture elements, in particular seating furniture elements such as backrests or seat elements as well as corresponding furniture elements as such.

In particular in the area of the furniture industry, high requirements are imposed on textile surface materials which are used, for example, as covering materials or coverings of carrier or frame devices in particular for providing backrests or seat elements or seat surfaces for seating furniture or the like:

Thus, it is generally required that the textile surface materials used as covering materials or coverings have a high mechanical stability in order in particular to be able to absorb the loads or actions of forces which occur during appropriate use (“sitting down”) when used as backrests or seat surfaces, wherein in this context the textile surface materials used should also have corresponding (stretch) recovery properties in order to avoid an undesirable permanent flattening of the covering or a corresponding loss of tension after intensive or long-term use of the basic seating furniture. In this case, it is in particular also necessary that in particular in the area of the furniture industry, preferably for seating furniture or the like, textile surface materials used have a high reversible stretchability. In this context, the displacement resistance of the yarns used forming the basis of the textile surface material also has a high importance since a correspondingly high sliding strength (sliding resistance) allows a high mechanical stability even whilst permanently maintaining the tensioning force when coverings are used in particular for seating furniture. However, the surface materials provided in the prior art in this respect are not always capable of satisfactorily meeting the aforesaid requirements.

Furthermore, it is frequently problematical in the prior art to produce fold-free covers or coverings for example of carrier or (tensioning) frame devices for seating furniture or the like, in particular since undesired folds or the like frequently form in the area of fastening the textile surface material on or to the carrier or (tensioning) frame. With a view to providing as far as possible fold-free covers or coverings, in this context attempts have been made in the prior art to provide correspondingly exact blanks or stitching of the textile surface materials used or to configure corresponding covers or coverings as multipart in order to enable a corresponding geometric matching to the carrier or (tensioning) frame device.

However, such a procedure is complex from the production technology viewpoint and in addition cost-intensive, wherein furthermore the shaping or design freedom of the relevant covers or coverings is reduced. In addition, corresponding seam joins such as are required in particular in multipart configurations of the covers or coverings in order to enable a corresponding shape matching, in some cases form weak spots with regard to the loading capacity and durability of the materials used. In the case of correspondingly complicated or complex shapes of the furniture to be covered or spanned such as seating furniture, frequently an undesired fold formation or bulging additionally occurs in the area of the basis geometries, shapings, contours, taperings, curves or the like of the carrier or frame device.

In addition to the high mechanical requirements, it is furthermore likewise necessary that the textile surface materials used as covering fabrics or coverings enable an appropriate sitting comfort or a high ergonomy, accompanied by the provision of a high comfort in the usage state, in particular in connection with seating furniture and the relevant area of application or use.

Within the framework of the production in particular of coverings for corresponding backrests or seat elements of seating furniture, it is frequently provided in the prior art that the corresponding covers or coverings are already applied under (pre-) tension to a carrier or frame device or fixed hereon, which is however likewise accompanied by production technology disadvantages.

In order to reduce fold formation here in particular, it can generally be provided in the prior art to use suitably elastically configured textile materials. Materials of this type as such are, however, fundamentally not suitable as covers or coverings which in particular are fastened to a carrier or frame device at the edge since the textile materials in question in some cases do not have the (self-) tensioning force required for a functional and permanent covering.

In this context, WO 03/047395 A1 or EP 1 450 649 A1 or US 2003/122411 A1 which belong to the same patent family relate to a stretchable cover for an elastic cushion wherein the cover in question comprises a woven fabric having a certain elastic recovery force.

Furthermore, the present cover or covering systems in the prior art frequently do not comprise reversibly compressible structures which however reduces the sitting comfort when seating furniture produced on this basis is used, in particular as far as an ergonomic adaptation of the seating furniture or the relevant covers or coverings to the contours of the body is concerned.

At the same time, in the prior art there is a great need for efficient methods for providing corresponding textile cover or covering materials wherein the basic methods should result in high-performance products which can then be supplied to an end processing (in particular covering of corresponding carrier structures such as carrier or frame devices of seating furniture or the like, for the provision in particular of seating furniture or the like), wherein at the same time a high flexibility and variability with regard to the specific configuration of the basic products is required with high procedural economy and cost efficiency at the same time, which in the prior art is thus in some cases not sufficiently given.

### BRIEF SUMMARY OF THE INVENTION

Against this background, it is therefore an object of the present invention to provide a special textile-based material and a method for producing the textile-based material wherein the previously described disadvantages of the prior art should be avoided or however at least mitigated. In particular, within the framework of the present invention, a textile-based material should be provided, which is suitable in particular as upholstery or covering material for seating furniture and in this respect in particular for the formation or provision of backrests and of seat elements or surfaces.

In this context, a further object of the present invention is to provide a textile-based material or a relevant method for the production thereof, wherein the material in particular within the framework of the use as an upholstery or covering material should enable a fold-free cover or a correspondingly fold-free covering of basic carrier or frame devices or structures, in particular for seating furniture such as chairs or the like. In addition, the textile-based material provided according to the invention should at the same time have good reversible stretchability properties or a high stretch recovery even after high forceful stressing.

A further object of the present invention can additionally be seen in providing a special textile-based material which has a high comfort or improved (sitting) ergonomic properties with at the same time high load-bearing capacity or stability in particular within the framework of the use as upholstery or covering material, preferably for seating furniture or the like.

In addition, within the framework of the present invention according to another further object of the present invention, an overall simplified from the production technology viewpoint and less cost-intensive method for producing the textile-based material in question is to be provided, by means of which a high flexibility and variability with regard to the formation of specific products is ensured.

The object forming the basis of the present invention is in the present case solved—according to a first aspect of the present invention—by a method for producing a textile composite material having shrink properties, in particular heat shrink properties, preferably in the form of a shrinkable, in particular heat-shrinkable textile upholstery or covering material, preferably for seating furniture. Further advantageous configurations of the method according to the invention are provided.

A further subject matter of the present invention—according to a second aspect of the invention—is the textile composite material which can be obtained according to the method according to the present invention or the textile composite material having shrink properties, in particular heat shrink properties. Further advantageous embodiments of the textile composite material having shrink properties, in particular heat shrink properties according to the invention are also provided.

A further subject matter of the present invention—according to a third aspect of the invention—is the shrunk, in particular heat-shrunk textile composite material described. Further advantageous embodiments of the shrunk, in particular heat-shrunk textile composite material are disclosed.

Yet another subject matter of the present invention—according to a fourth aspect of the present invention—is the use of the textile composite material having shrink properties, in particular heat shrink properties according to the invention to produce or manufacture the shrunk, in particular heat-shrunk textile composite material according to the current disclosure.

Yet another subject matter of the present invention—according to a fifth aspect of the present invention—is the method for producing the shrunk, in particular heat-shrunk textile composite material.

In addition, a further subject matter of the present invention—according to a sixth aspect of the present invention—is the use of the textile composite material having shrink properties, in particular heat shrink properties, or of the shrunk, in particular heat-shrunk textile composite material according to the invention in the area of the furniture industry, automobile industry or the like.

In this context, the subject matter of the present invention—according to a seventh aspect of the present invention—is also the use of the textile composite materials in question to produce furniture elements, in particular seating furniture elements.

The subject matter of the present invention—according to an eighth aspect of the present invention—is in addition the method for producing furniture elements, in particular seating furniture elements.

Finally the subject matter of the present invention—according to a ninth aspect of the present invention—are furniture elements as such, in particular seating furniture elements

It is obvious that in the following description of the present invention, those configurations, embodiments, advantages, examples or the like which hereinafter—for the purposes of avoiding unnecessary repetitions—are only explained for a single aspect of the invention naturally also apply accordingly in relation to the other aspects of the invention without this needing to be expressly mentioned.

It is furthermore obvious that in the following specifications of values, numbers, and ranges, the relevant value, number, and range information is not to be understood as restrictive; it is obvious for the person skilled in the art that deviations from the specified ranges or information can occur due to individual cases or related to applications without departing from the framework of the present invention.

In addition, it holds that all the value or parameter information or the like mentioned in the following can fundamentally be determined or ascertained using normalized or standardized or explicitly specified methods of determination or however methods of determination or measurement otherwise familiar to the person skilled in the art in this field per se. Unless specified otherwise, the basic values or parameters are determined under standard conditions (i.e. in particular at a temperature of 20° C. and/or at a pressure of 1013.25 hPa or 1.01325 bar).

It also holds that in all the relative or percentage, in particular weight-related quantitative information recited below it should be noted that this information should be selected or combined by the person skilled in the art within the framework of the present invention in such a manner that in total—optionally also including further components or contents, in particular as defined hereinafter—100% or 100 wt % is always obtained. However, this is obvious for the person skilled in the art.

With this proviso, the present invention is described and explained in more detail in the following and specifically also with reference to drawings or figures showing embodiments or exemplary embodiments according to the invention. In connection with the explanation of these preferred embodiments or exemplary embodiments of the present invention which however are in no way restrictive in relation to the present invention, further advantages, properties, and features of the present invention are also indicated.

### BRIEF DESCRIPTION OF THE DRAWINGS

FIG. 1A shows a schematic diagram of the procedure according to the invention to obtain the textile composite material having shrink properties, in particular heat shrink properties according to a first embodiment according to the invention, according to which firstly the sliding or protective material is applied to the foam-based surface material and the foam-based surface material is additionally or at the same time applied to the textile carrier layer, followed by an application of the upper and cover material;

FIG. 1B shows another schematic diagram of the procedure according to the invention according to a further embodiment of the present invention, according to which firstly the foam-based surface material is provided with a textile sliding or protective material and then the composite is applied to the textile carrier material, followed by an application of the upper and cover material;

FIG. 1C shows yet another schematic diagram of the procedure according to the invention according to yet another embodiment, according to which firstly the foam-based surface material is joined to the textile carrier layer, followed by an application of the textile sliding or protective material with subsequent application of the upper and cover material;

FIG. 2A shows a schematic sectional view of a textile composite material according to the invention, according to which the shrinkable, in particular heat-shrinkable textile carrier layer, the foam-based surface material, and the textile sliding or protective material form a laminate structure;

FIG. 2B shows a schematic sectional view of a further textile composite material according to the invention, according to which the textile composite material described in FIG. 2A is additionally supplied with a textile upper and cover material;

FIG. 3A shows a schematic diagram of the shrinkable, in particular heat-shrinkable textile carrier layer in plan view, according to which the carrier layer is configured in the form of a woven fabric;

FIG. 3B shows a schematic diagram of the shrinkable, in particular heat-shrinkable textile carrier layer according to a further embodiment according to the invention, according to which the carrier layer is configured in the form of a knitted fabric;

FIG. 4A shows a schematic diagram of a heat-shrunk textile composite material according to the invention with the relevant layer or material sequence and the shrunk, in particular heat-shrunk textile carrier layer.

### DETAILED DESCRIPTION OF THE INVENTION

The subject matter of the present invention—according to a first aspect of the present invention—is therefore a method for producing a textile composite material having shrink properties, in particular heat shrink properties, preferably in the form of a shrinkable, in particular heat-shrinkable textile upholstery and/or covering material, preferably for seating furniture, wherein a shrinkable, in particular heat-shrinkable textile carrier layer is joined, preferably extensively joined, in particular adhesively bonded, to at least one foam-based surface material, in particular foam layer, using at least one binder, in particular adhesive, at a temperature below the shrink temperature, in particular heat shrink temperature, of the textile carrier layer and wherein the foam-based surface material is provided on the side facing away from the textile carrier layer with at least one in particular extensive textile sliding and/or protective material.

As a result of the method according to the invention, a special textile composite material having shrink properties, in particular heat shrink properties is provided, which is associated with the central advantage that as a result of defined shrink properties, the material can be fixed or spanned for example directly onto a carrier or frame device (i.e. in particular carrier or frame device for receiving textile coverings or the like) to provide, for example, backrests or seat elements for seating furniture, wherein as a result of shrinkage, in particular heat shrinkage of the spanned composite material to be carried out subsequently, a fold-free and force-resistant covering of the corresponding carrier or frame device is obtained. At the same time, another central advantage can be seen in that the textile composite material provided by the method according to the invention in particular as a result of the specific provision of a (pressure-) compressible foam-based surface material with at the same time fold-free cover or fold-free covering enables an efficient upholstering and therefore a high ergonomy or, in the case of application to seating furniture such as chairs, a high sitting comfort. The textile composite material according to the invention thus combines the diametrically opposed properties of the provision of a high sitting comfort on the one hand and after carrying out the shrinkage, in particular heat shrinkage, as a result of the resulting high (intrinsic) tension, a fold-free and permanently force-resistant covering of the basic carrier or frame device on the other hand.

On the basis of the method according to the invention, a textile composite material having shrink properties is thus provided which already as such has corresponding upholstery properties so that a subsequent plumping up which is complex from the process technology viewpoint can be omitted. In particular, as a result of the method according to the invention, a ready-to-use material is provided which can be individually tailored with a view to the respective usage application. In particular within the framework of the present invention, the subsequent application of additionally stabilizing structures as well as ergonomy-enhancing elements such as foam cushions or the like can be omitted since the ready-to-use textile composite material can so to speak be spanned directly without further stabilizing or supporting measures onto a carrier or frame device in particular in a self-supporting manner.

In this context, an advantage of the present invention can also be seen in that the textile composite material having shrink properties, in particular heat shrink properties can be applied to a carrier or frame device or structure or fixed thereon such than in this respect an exact or complex tailoring or an exact stitching is fundamentally not necessary, in particular since the textile composite material can generally be used as one-piece material. This is because as a result of the (heat) shrinkage to be carried out preferably after the attachment or application to a carrier or frame device, as a result of the (heat) shrink properties of the textile composite material according to the invention, the textile surface material according to the invention is to a certain extent smoothed and spanned on the carrier or frame or set under (self-) tension so that an at least substantially fold-free cover or a fold-free covering is obtained which at the same time has the upholstery properties in question. As a result of the heat shrink process, a defined (self-) tension of the textile composite material according to the invention applied previously to a carrier or frame structure is also built up so that as a result of the pre-tension, a high force load-bearing capacity is obtained and specifically without the textile composite material according to the invention being excessively stretched or excessively flattened and without the layers applied to the carrier material separating or delaminating.

In this context, it is additionally ensured that the foam-based surface material applied to the shrinkable, in particular heat-shrinkable textile carrier layer does not delaminate or become detached from the textile carrier layer during the (heat) shrinkage, which is ensured in particular due to the use of a very special binder, in particular adhesive. According to the invention, a firmly joined unit of the respective layers, in particular based on the textile carrier layer on the one hand and the foam-based surface material and the sliding or protective material on the other hand is thus provided, which simplifies the (heat) shrinkage to be carried out in particular after application or attachment of the composite material to a carrier or frame device.

As is specified hereinafter, the textile composite material provided by the method according to the invention can also be equipped with a textile upper or cover material so that the textile composite material can be individually adjusted or tailored with regard to its surface properties, in particular optics and haptics, and its textile properties.

In this context, in addition the specific use of the textile sliding or protective material which is generally arranged between the foam-based surface material on the one hand and the textile upper or cover material results in a high or improved compatibility of the surface materials used overall, in particular as far as a further protection of the foam-based surface material is concerned through provision or enablement of a specific “sliding” of the textile upper or cover material on the sliding or protective material or the textile composite material overall, which additionally counteracts the formation of folds or bulges and an excessive wear.

As will be explained in further detail below, within the framework of the method according to the invention, the shrink properties, in particular heat shrink properties of the textile carrier layer of the textile composite material provided according to the invention are provided by the specific use of a shrinkable, in particular heat-shrinkable plastic yarn, which is part of the textile carrier layer. By this means the shrink properties can be specifically predefined or set.

Furthermore the textile composite material produced by the method according to the invention has optimized reversible stretching properties, which has the result that the textile composite material according to the invention, which is applied in heat-shrunk form to a carrier or frame device, for example, to provide a backrest or seat surface of a chair or the like, can be further adapted to the body contour of a user, so that on this basis and combined with the foam-based surface material, a high (sitting) ergonomy is obtained. In this context, a further advantage can be seen in that after a force stressing, which can be accompanied by a stretching or a flattening of the textile composite material according to the invention, the textile composite material according to the invention to a certain extent again acquires its original shape as a result of the high recovery force of the textile carrier layer so that likewise excellent stretch recovery properties are provided according to the invention. This can be brought about or further improved, as will be explained below, by the specific use of stretchable yarns or fibers such as elastomer or rubber threads or yarns.

The method according to the invention thus yields a high-performance textile composite material having defined shrink properties with high comfort and high stability of the basic layer composite. The method according to the invention at the same time enables a high flexibility or variability with regard to the specific formation and adaptation of the textile composite material in relation to the specific usage purpose.

In particular, as a result of the very special concept according to the invention of the use of a special binder, in particular adhesive, which specifically adhesively bonds or forms adhesive bonds below the temperatures provided for shrinkage of the material or which at the temperatures prevailing in the course of the shrinkage does not melt or decay with degradation of the adhesive bonds, it is ensured that a stable (layer) composite of the material provided according to the invention is obtained even under the further processing in the form of the (heat) shrinkage.

The method according to the invention is additionally characterized by a high procedural economy or cost efficiency.

A further advantage of the textile composite material according to the invention as provided by the method according to the invention consists in that as a result of the (heat) shrink properties, there is a high flexibility in relation to the carrier or frame structure to be covered or spanned, wherein strongly defined geometries or shapes and contours such as tapers, curves, bends, and the like can also be covered or spanned in an effective manner avoiding any excessive fold formation.

According to the invention in this context, the term “heat-shrinkable” is understood in particular as a size change caused or induced by the influence of heat or temperature in particular in the area and therefore in particular in the main extension plane or in at least one direction of extension of the textile composite material or the textile carrier layer of the textile composite material, wherein this is caused in particular by a shortening or reduction in length of the heat-shrinkable plastic yarn used according to the invention, wherein equally a thickening, i.e. an increase in the diameter of the plastic yarn can be present in relation to the (heat-) shrinkable plastic yarn in the course of the shrinking. The (heat) shrinking within the framework of the present invention thus in particular involves a controlled reduction in size or length of the plastic yarn used and therefore of the textile carrier layer of the textile composite material. In particular, the (heat) shrinkage present during the subsequent processing according to the invention of the composite material provided according to the invention comprises an at least substantially irreversible shrinkage process.

In this context, the term “shrink temperature” or “heat shrink temperature” as used in the framework of the present invention should be understood in particular in such a manner that at the corresponding temperature there is an effective heat shrinkage in particular of the textile carrier material with heat shrink properties forming the basis of the composite material according to the invention.

The present invention is explained in detail hereinafter with reference to drawings or figures showing preferred exemplary embodiments. In connection with the explanation of these preferred exemplary embodiments of the present invention which are however in no way restrictive in relation to the present invention, further advantages, properties, aspects, and features of the present invention will also be described.

In the figures:

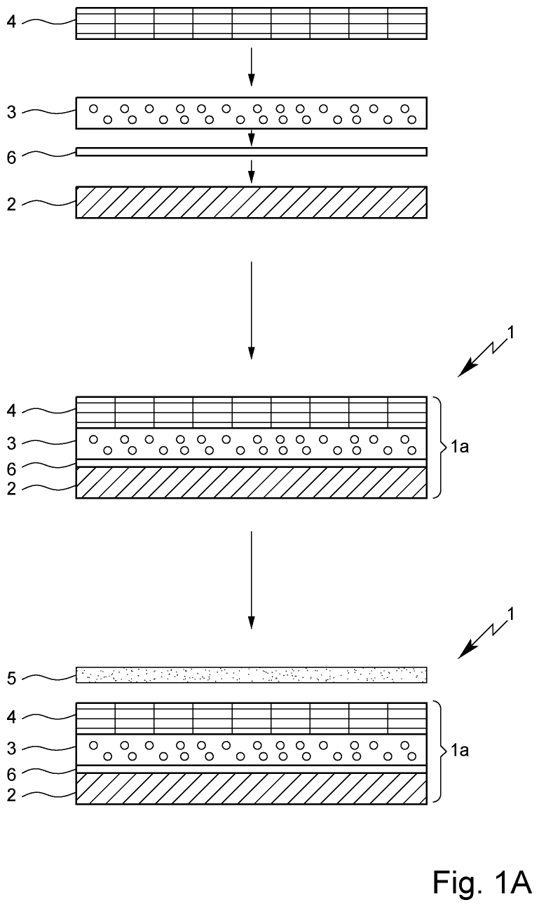

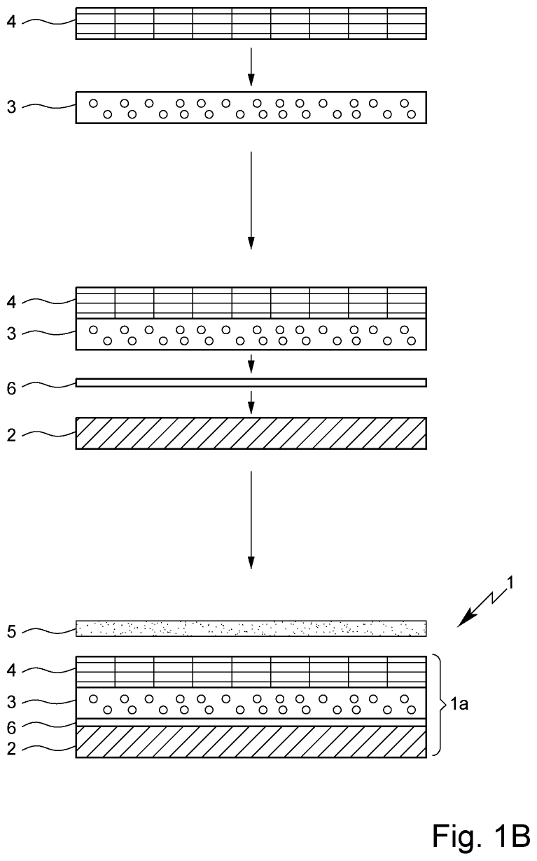

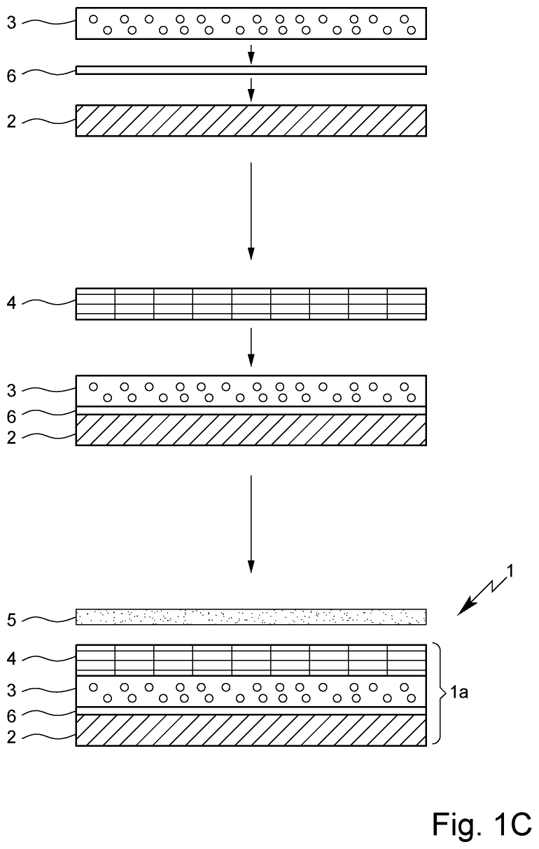

FIG. 1A shows a schematic diagram of the procedure according to the invention to obtain the textile composite material having shrink properties, in particular heat shrink properties according to a first embodiment according to the invention, according to which firstly the sliding or protective material is applied to the foam-based surface material and the foam-based surface material is additionally or at the same time applied to the textile carrier layer, followed by an application of the upper and cover material;

FIG. 1B shows another schematic diagram of the procedure according to the invention according to a further embodiment of the present invention, according to which firstly the foam-based surface material is provided with a textile sliding or protective material and then the composite is applied to the textile carrier material, followed by an application of the upper and cover material;

FIG. 1C shows yet another schematic diagram of the procedure according to the invention according to yet another embodiment, according to which firstly the foam-based surface material is joined to the textile carrier layer, followed by an application of the textile sliding or protective material with subsequent application of the upper and cover material;

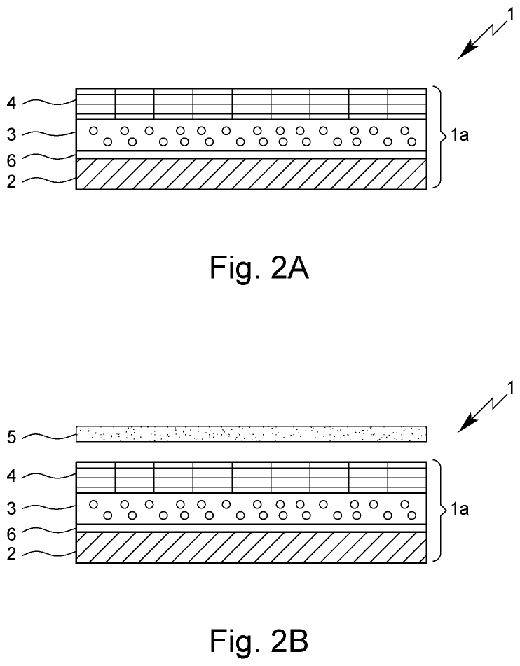

FIG. 2A shows a schematic sectional view of a textile composite material according to the invention, according to which the shrinkable, in particular heat-shrinkable textile carrier layer, the foam-based surface material, and the textile sliding or protective material form a laminate structure;

FIG. 2B shows a schematic sectional view of a further textile composite material according to the invention, according to which the textile composite material described in FIG. 2A is additionally supplied with a textile upper and cover material;

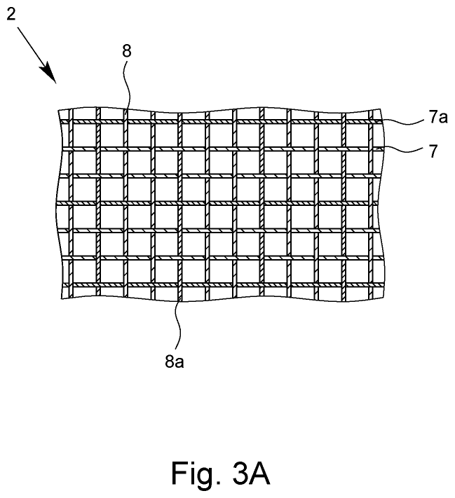

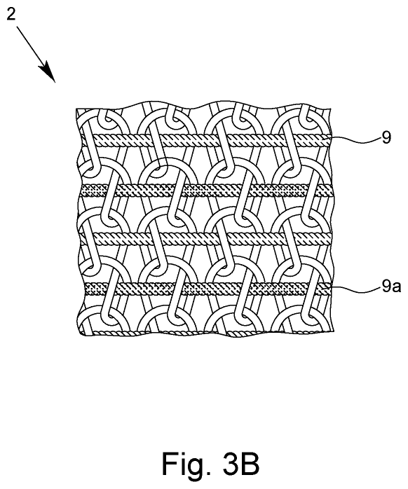

FIG. 3A shows a schematic diagram of the shrinkable, in particular heat-shrinkable textile carrier layer in plan view, according to which the carrier layer is configured in the form of a woven fabric;

FIG. 3B shows a schematic diagram of the shrinkable, in particular heat-shrinkable textile carrier layer according to a further embodiment according to the invention, according to which the carrier layer is configured in the form of a knitted fabric;

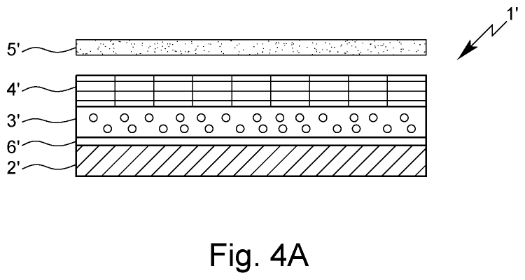

FIG. 4A shows a schematic diagram of a heat-shrunk textile composite material according to the invention with the relevant layer or material sequence and the shrunk, in particular heat-shrunk textile carrier layer.

FIGS. 1A, 1B and 1C thus show the procedure forming the basis of the method according to the invention: in particular the figures show the method according to the invention for producing a textile composite material 1 having shrink properties, in particular heat shrink properties, preferably in the form of a shrinkable, in particular heat-shrinkable, textile upholstery and/or covering material, preferably for seating furniture, wherein a shrinkable, in particular heat-shrinkable textile carrier layer 2 is joined, preferably extensively joined, in particular adhesively bonded, to at least one foam-based surface material 3, in particular foam layer, using at least one binder 6, in particular adhesive, at a temperature below the shrink temperature, in particular heat shrink temperature, of the textile carrier layer 2 and wherein the foam-based surface material 3 is provided on the side facing away from the textile carrier layer 2 with at least one in particular extensive textile sliding and/or protective material 4.

In particular, the textile composite material 1, in particular the sliding and/or protective material 4, can be equipped with and/or supplied with at least one textile upper and/or cover material 5 or can comprise this. In particular, the textile upper or cover material 5 can be applied on the side of the textile sliding and/or protective material 4 facing away from the foam-based surface material 3, as shown in FIGS. 1A to 1C.

FIGS. 1A, 1B, and 1C additionally show that according to the method according to the invention, at least one textile upper and/or cover material 5 can be applied to the sliding or protective material 4. The application of the textile upper and/or cover material 5 can in particular be made on the side of the textile sliding and/or protective material 4 facing away from the foam-based surface material 3.

According to the invention, it can generally also be provided that the textile composite material 1, in particular the sliding and/or protective material 4, is equipped with and/or supplied with at least one textile upper and/or cover material 5, wherein the upper and/or cover material 5 is equipped with and/or supplied with, preferably joined to, in particular adhesively bonded and/or laminated to the sliding and/or protective material 4 on the side facing the foam-based surface material 3. Accordingly, firstly a so-to-speak upstream equipping of the upper and/or cover material 5 with the sliding and/or protective material 4 can be accomplished, in particular followed by an application or a fastening of the composite of upper and/or cover material 5 and sliding and/or protective material 4 on the foam-based surface material 3, which in turn can be applied previously to the textile carrier layer 2.

According to the invention, in particular it is possible to proceed in such a manner that the layers or materials listed hereinafter form a laminate or a laminate material 1a within the composite material 1 provided according to the invention:

Thus, according to the invention for example it is possible to proceed in such a manner that, as shown in FIG. 1A, firstly the textile carrier layer 2, the foam-based surface material 3 and the textile sliding or protective material 4 are joined to one another, preferably extensively joined, in particular adhesively bonded in particular to form or provide the laminate material 1a. In this respect, optionally an equipping with or application of the textile upper or cover material 5, in particular to obtain the composite material 1, can be carried out subsequently.

According to the invention, it is possible to proceed in such a manner that the equipping with or application of the textile upper or cover material 5 is carried out after the joining, preferably extensive joining, in particular adhesive bonding, of the textile carrier layer 2, the foam-based surface material 3 and the textile sliding or protective material 4, and/or after the formation and/or provision of the laminate material 1a, as shown in particular in FIGS. 1A to 1C.

In this context, in particular the application of or equipping with the textile upper or cover material 5 can thus be accomplished temporally and/or spatially separately from the production of the laminate material 1a, which is associated with the advantage that an individual assembly of the composite material 1 according to the invention can only be accomplished in the course of the further processing, in particular to backrests or seat elements for seating furniture at the manufacturer of corresponding furniture elements. According to the invention, it is thus possible to proceed in particular in such a manner that firstly the laminate material 1a, as specified previously, is formed or provided and then the textile upper or cover material 5 is applied in particular to obtain the composite material 1.

Likewise however it lies within the framework of the present invention if firstly the textile sliding and/or protective material 4 and the textile upper and/or cover material 5 are joined to one another, in particular adhesively bonded and/or laminated at least in sections and then the sliding and/or protective material 4 provided with the upper and/or cover material 5, in particular on the side facing away from the upper and/or cover material 5, is joined, preferably extensively joined, in particular adhesively bonded and/or laminated to the foam-based surface material 3. In this case, the foam-based surface material 3 can again be applied previously to the textile carrier material 2.

As shown in FIG. 1B, it is also possible to proceed according to the invention in such a manner that firstly the foam-based surface material 3 and the textile sliding and/or protective material 4 are joined to one another, preferably extensively joined, in particular adhesively bonded and/or laminated and specifically in particular using a binder 6. Then the foam-based surface material 3 provided with the sliding or protective material 4 can be joined, preferably extensively joined, in particular adhesively bonded, to the textile carrier material 2, and specifically in particular on the side facing away from the sliding or protective material 4 or in particular to form or provide the laminate material 1a. Finally the equipping with the textile upper or cover material 5 can be accomplished.

As shown in FIG. 1C, it is furthermore possible to proceed according to the invention in such a manner that initially the textile carrier material 2 and the foam-based surface material 3 are joined together, preferably extensively joined, in particular adhesively bonded and then the foam-based surface material 3 provided with the textile carrier material 2 is joined, preferably extensively joined, in particular adhesively bonded and/or in particular laminated to the sliding or protective material 4, in particular on the side facing away from the textile carrier material 2 or in particular to form and/or provide the laminate material 1a. Here also an equipping with the textile upper or cover material 5 can be accomplished subsequently.

Likewise it is also possible to proceed according to the invention in such a manner that all the layers forming the basis of the composite material 1 according to the invention (i.e. the textile carrier layer 2, the foam-based surface material 3 with the binder 6, the sliding or protective material 4 as well as the upper or cover material 5) are joined to one another at the same time or applied to one another.

The textile composite materials 1 according to the invention can thus be obtained on the basis of the procedure according to the invention, as also shown in FIGS. 2A, 2B.

As far as the binder 6, in particular adhesive, used in the method according to the invention is concerned, this can be an adhesive which forms adhesive bonds or adhesive forces below the shrink temperature, in particular heat shrink temperature, of the textile carrier layer 2.

In this context, an adhesive which forms adhesive bonds and/or adhesive forces at temperatures of at most 100° C., in particular at most 80° C., preferably at most 60° C., preferably at most 40° C., can be used as binder 6, in particular adhesive.

As a result of the specific use of a binder 6 or adhesive of the aforesaid type, within the framework of the procedure according to the invention, it is in particular ensured that the composite material 1 according to the invention or the textile carrier layer 2 at least substantially does not shrink during the adhesive bonding of the respective layers so that prior to its further processing to produce in particular backrests or seat surfaces or elements or the like, a premature or undesired shrinkage of the composite material 1 according to the invention is avoided.

According to the invention, a thermally stable binder 6, in particular adhesive, in particular at temperatures of up to 100° C., in particular of up to 140° C., preferably of up to 180° C., preferably of up to 200° C., particularly preferably of up to 240° C., can be used as binder 6, in particular adhesive. In this case, the term “thermally stable” relates in particular to the property of the binder whereby at the temperatures in question, adhesive bonds or adhesive forces which are already present are at least maintained insofar as a delamination or a detachment of the layers or materials of the textile composite material 1 is prevented or whereby adhesive bonds or adhesive forces which are already present at the specified temperatures at least substantially remain so that in the course of the (heat) shrinkage which is only carried out after production of the composite material 1 according to the invention in the course of the further processing to finished products, no delamination or no detachment of the respective layers or materials takes place.

According to the invention, it is additionally preferred in this context if a moisture cross-linking or heat cross-linking adhesive, in particular reactive hot melt adhesive, preferably polyurethane-based is used as binder 6, in particular adhesive.

In particular, an adhesive based on at least one polyol, in particular polyester polyol, on the one hand and an isocyanate, in particular diphenylmethane diisocyanate (MDI) and/or toluene diisocyanate (TDI), on the other hand can be used as binder 6, in particular adhesive, according to the method according to the invention.

By using a special binder 6, in particular as defined previously, it is ensured that during the (heat) shrinkage of the composite material 1 according to the invention provided during the further processing, the adhesive bonds formed between the respective layers are not released and therefore no delamination takes place under the influence of heat either. According to the invention, a thermally stable laminate or composite material 1 is thus provided on the basis of the very special procedure with regard to the layer composite, which is accessible to a subsequent (heat) shrink process without destruction or delamination.

In particular, the binder 6, in particular adhesive, according to the method according to the invention can be used in a quantity in the range of 5 g/m² to 200 g/m², in particular in the range of 10 g/m² to 150 g/m², preferably in the range of 15 g/m² to 100 g/m², preferably in the range of 20 g/m² to 80 g/m², or can be applied to the foam-based surface material 3 or the textile carrier layer 2, in particular to the foam-based surface material 3. This ensures a good adhesive bond.

At the same time, it is in particular provided within the framework of the present invention that the binder 6, in particular adhesive, is applied continuously or discontinuously, in particular continuously, as shown schematically in particular in FIGS. 1A to 1C, to the foam-based surface material 3 and/or the textile carrier layer 2, in particular to the foam-based surface material 3.

In order to enable an effective application of adhesive, the binder 6, in particular adhesive, can be applied, preferably in terms of procedure, by means of roller application, spray and/or nozzle application or squeegee application, in particular roller application or nozzle and/or spray application, to the foam-based surface material 3 and/or the textile carrier layer 2, in particular to the foam-based surface material 3. In particular, a slotted nozzle application of the binder 6 is also considered.

According to the invention, the binder 6 or adhesive is applied in particular before joining together the basic materials.

According to the invention, it can also be provided that the binder 6, in particular adhesive, is applied discontinuously, in particular so that a discontinuous joining of the respective layers is accomplished, for example, based on a punctuate or grid-shaped application of the binder 6, in particular adhesive to the textile carrier layer 2 and/or the foam-based surface material 3.

Within the framework of the present invention, it is in this case in particular provided, as specified previously, that the adhesive bonds obtained in the course of the production of the textile composite material 1′ according to the invention are at least substantially completely maintained during the subsequent (heat) shrink process to obtain the (heat-) shrunk textile composite material 1′ so that a corresponding composite or laminate, as described previously, exists in relation to the resultant (heat-) shrunk textile composite material 1′.

In addition, it can be provided according to the invention that the sliding or protective material 4 is joined, preferably extensively joined, in particular adhesively bonded and/or in particular laminated to the foam-based surface material 3. In this respect, the joining can take place by means of laminating, in particular flame laminating. The relevant measures are well known as such to the person skilled in the art so that no further explanations are required in this respect. Alternatively the joining of the sliding or protective material 4 to the foam-based surface material 3 can also be accomplished or carried out by means of a binder, in particular adhesive, preferably as defined previously.

According to the invention, it is additionally preferred if the textile upper and/or cover material 5 is applied to the sliding and/or protective material 4 or the laminate material 1a at least substantially loosely or to form a loose composite. By this means it is further ensured that the visible or usage surface of the textile composite material 1 does not throw up any folds even under high force stressing or compression of the foam-based surface material 3 in the usage state, in particular since the textile upper and/or cover material 5 can, so to speak, slide on the textile sliding or protective material 4.

In particular, in this case it can be provided according to the invention that the upper or cover material 5 is joined, in particular sewn, welded, tacked, clamped or adhesively bonded, in particular sewn in sections, in particular at the edge, to the sliding or protective material 4 and/or the laminate material 1a. This ensures overall that the textile upper or cover material 5 does not slip and thus an overall stable composite is formed. The in particular edge-side joining or fastening of the upper or cover material 5 to the sliding or protective material 4 and/or the laminate material 1a can also be made, for example, by means of a free or piping edge (piping) or the like.

In this context, an edge-side joining of the upper or cover material 5 in particular to the sliding or protective material 4 or the laminate material 1a can also be made via a carrier or (tensioning) frame device provided in particular when providing backrests or seat elements, for example, by a clamping of the respective layers or the like.

According to less preferred embodiments, it is however fundamentally also possible that the textile upper or cover material 5 is joined, in particular adhesively bonded, at least substantially extensively to the sliding or protective material or the laminate material 1a. In this respect, a laminating or the like can also be accomplished. In general, the previously described binder 6 can be used for this purpose.

As far as the carrier layer 2 used within the framework of the method according to the invention is furthermore concerned, this can be present in numerous embodiments:

Thus, the textile carrier layer 2 can be used or configured in the form of a woven fabric; a knitted fabric, in particular a knitted fabric or crocheted fabric; a scrim or a textile composite material, in particular nonwoven.

In particular, the textile carrier layer 2 can be used or configured in the form of a woven fabric, knitted fabric or crocheted fabric, preferably in the form of a woven fabric. In this context FIG. 3A shows the configuration of the textile carrier layer 2 in the form of a woven fabric whilst FIG. 3B shows the embodiment according to the invention according to which the textile carrier layer 2 is configured in the form of a knitted fabric, in particular in the form of a knitted fabric.

The (heat) shrink properties forming the basis of the textile composite material 1 according to the invention or the textile carrier layer 2 are ensured according to the invention in particular in that the textile carrier layer 2 comprises at least one shrinkable, in particular heat-shrinkable plastic yarn or is equipped with this in the course of the method according to the invention. As a result of the use of a heat-shrinkable plastic yarn, a defined shrinkage behavior can be adjusted with regard to the subsequent further processing, which leads to exceptional and reproducible (shrink) properties of the composite material 1 according to the invention. According to the invention, it is additionally proceeded in particular in such a manner that, as further specified hereinafter, the heat-shrinkable plastic yarn is used in addition to at least one further, non-heat-shrinkable yarn component or a relevant yarn in the textile carrier layer 2.

The heat-shrinkable plastic yarn provided in the method according to the invention can in this case be used in numerous configurations in the textile carrier layer 2:

In particular, in this context as shown in FIG. 3A, the textile carrier layer 2 can be used or configured in the form of a woven fabric, wherein the woven fabric comprises—preferably in addition to or alongside non-shrinking weft threads or yarns 7 and non-shrinking warp threads or yarns 8—corresponding (heat) shrink weft threads and/or yarns 7a and/or (heat) shrink warp threads and/or yarns 8a. In this case, the (heat) shrink weft threads and/or yarns 7a and/or the (heat) shrink warp threads and/or yarns 8a can comprise, independently of one another, at least one shrinkable, in particular heat-shrinkable plastic yarn or consist thereof.

In addition, it can be provided according to the invention in this context, as shown in FIG. 3B, that the textile carrier layer 2 is used and/or configured in the form of a knitted fabric, in particular a knitted fabric or crocheted fabric, preferably in the form of a knitted fabric.

In this context, the knitted fabric, in particular the knitted fabric or crocheted fabric, preferably the knitted fabric, can have a foundation, in particular selected from the group of pillar stitch, stockinet, cloth, satin, velvet and atlas. In this context, the foundation can comprise at least one shrinkable, in particular heat-shrinkable plastic yarn or consist thereof.

In particular, the knitted fabric, in particular the knitted fabric or crocheted fabric, preferably the knitted fabric can comprise at least one binding element 9, in particular selected from the group of weft, inlay, filler thread and/or yarn, loop and float stitch. In this respect, reference can also be made to FIG. 3B.

In particular, the knitted fabric, in particular the knitted fabric or crocheted fabric, preferably the knitted fabric, as shown in FIG. 3B, can comprise at least one (heat) shrink binding element 9a, in particular selected from the group of (heat) shrink weft, (heat) shrink inlay, (heat) shrink filler thread and/or yarn, (heat) shrink loop, and (heat) shrink float stitch. In this context, the (heat) shrink binding element 9a can comprise at least one shrinkable, in particular heat-shrinkable plastic yarn or consist thereof.

In a corresponding manner, the textile carrier layer 2 in the form of a scrim or a textile composite material, in particular nonwoven can be equipped with the (heat) shrink elements cited previously for woven fabrics or knitted fabrics.

As far as the shrinkable, in particular heat-shrinkable plastic yarn used according to the invention is concerned, this can comprise a polyester based in particular on phthalate, preferably polyethylene terephthalate, polypropylene terephthalate, polybutylene terephthalate, preferably polyethylene terephthalate, or consist thereof.

In particular, the textile carrier layer 2 can contain the shrinkable, in particular heat-shrinkable plastic yarn in a quantity in the range of 1.5 wt. % to 55 wt %, in particular in the range of 2 wt % to 40 wt %, preferably in the range of 5 wt. % to 30 wt %, preferably in the range of 6 wt. % to 20 wt. %, particularly preferably in the range of 7 wt. % to 15 wt %, quite particularly preferably in the range of 8 wt. % to 10 wt %, relative to the textile carrier layer 2.

Likewise, the shrinkable, in particular heat-shrinkable plastic yarn used within the framework of the method according to the invention can have a shrinkage, in particular heat shrinkage in the range of 2% to 75%, in particular in the range of 5% to 60%, preferably in the range of 10% to 50%, preferably in the range of 15% to 40%, particularly preferably in the range of 20% to 35%, and/or more than 20%, relative to the length in the non-shrunk state and at a temperature of 140° C. to 240° C., in particular 160° C. to 200° C., preferably about 180° C.

In addition, the shrinkable, in particular heat-shrinkable plastic yarn used within the framework of the method according to the invention can have a shrinkage, in particular heat shrinkage, in the range of 2% to 40%, in particular in the range of 3% to 30%, preferably in the range of 4% to 30%, preferably in the range of 5% to 20%, particularly preferably in the range of 6% to 15%, and/or more than 10%, relative to the length in the non-shrunk state and at a temperature of 60° C. to 140° C., in particular 80° C. to 120° C., preferably about 100° C.

This results in overall defined and specific controllable shrink properties during the further processing in relation to the textile carrier layer 2 or the textile composite material 1 according to the invention as such. In addition, a premature (heat) shrinkage during production of the composite material 1 is avoided.

In general, it can be provided according to the invention that the textile carrier layer 2 comprises at least one yarn or corresponding fiber based on a yarn and/or fiber type, in particular textile yarn and/or fiber, which is in particular different from the shrinkable, in particular heat-shrinkable plastic yarn. In this case, the yarn and/or fiber type can comprise natural fibers or natural yarns, preferably wool fibers or yarns or cotton fibers or yarns (CO), preferably wool fibers or yarns, and/or chemical fibers or yarns, preferably synthetic fibers or synthetic yarns, in particular selected from the group of polyesters (PES); polyolefins, in particular polyethylene (PE) and/or polypropylene (PP); polyvinyl chloride (CLF); polyvinylidene chloride (CLF); acetate (CA); triacetate (CTA); polyacryl (PAN), polyamide (PA), in particular aromatic, preferably flame-retardant polyamides; polyvinyl alcohol (PVAL); polyurethanes; polyvinyl esters; (meth)acrylates; polylactic acids (PLA); as well as mixtures thereof, preferably polyamide (PA), or consist thereof.

As far as the foam-based surface material 3 used within the framework of the method according to the invention and shown schematically in FIGS. 1A to 1C is furthermore concerned, this can be used or configured in the form of an in particular thermoplastic foam based on polyolefins or polyurethanes, preferably polyurethanes.

In particular, the foam-based surface material 3 can be used or configured in the form of a closed-pore or closed-cell or however in the form of an open-pore and/or open-cell foam, preferably in the form of a closed-pore and/or closed-cell foam.

In addition, the foam-based surface material 3 can be used and/or configured in the form of an in particular closed-pore and/or closed-cell polyurethane foam.

In addition, the foam-based surface material 3 should have a thickness in the range of 0.5 mm to 100 mm, in particular in the range of 1 mm to 80 mm, preferably in the range of 2 mm to 50 mm, preferably in the range of 3 mm to 30 mm, particularly preferably in the range of 5 mm to 20 mm.

The previously described foam materials have overall exceptional compression and (compression) recovery properties and thus ensure an exceptional upholstery function and therefore a high sitting comfort when the textile composite material 1 according to the invention is used for example for backrests or seat elements of seating furniture such as chairs or the like.

As far as the textile sliding or protective material 4 is further concerned, which is likewise shown schematically in FIGS. 1A to 1C, it is preferred according to the invention if this is used and/or configured in the form of a woven fabric; a knitted fabric, in particular a knitted fabric or crocheted fabric; a scrim or a textile composite material, in particular a nonwoven.

According to the invention, it is however an advantage if the textile sliding and/or protective material 4 is used and/or configured in the form of a knitted fabric, in particular a knitted fabric or crocheted fabric, preferably in the form of a crocheted fabric, particularly preferably in the form of a circular knitted material.

In particular, it is preferred according to the invention if the textile sliding and/or protective material 4 is used or configured in the form of a circular knitted material. It can also be provided within the framework of the present invention that the textile sliding and/or protective material 4 is configured or used in the form of a locknit material.

In particular, the textile sliding or protective material 4 can comprise at least one synthetic yarn or corresponding fibers (chemical yarn or chemical fibers) or consist thereof. In particular, the synthetic yarn or the corresponding fibers can be selected from the group of polyesters (PES); polyolefins, in particular polyethylene (PE) and/or polypropylene (PP); polyvinyl chlorides (CLF); polyvinylidene chlorides (CLF); acetates (CA); triacetates (CTA); polyacrylonitrile (PAN); polyamides (PA); polyvinyl alcohols (PVAL); polyurethanes; polyvinyl esters; (meth)acrylates; as well as mixtures thereof, preferably polyesters (PES).

As a result of the special configuration of the textile sliding or protective material 4, on the one hand a defined slip or slide behavior of the textile upper or cover material 5 on the textile sliding or protective material 4 is made possible in relation to the textile upper or cover material 5 lying or arranged thereabove, whereby sliding or grating noises which may occur are effectively prevented or reduced. On the other hand, in particular for the foam-based surface material 3 arranged underneath the textile sliding or protective surface material 4, this results in a further protective function, in particular accompanied by a prevention of the release or breaking-off of individual fragments of the foam-based surface material 3, such as can be caused otherwise in particular in cases of persistent or excessive stressing accompanied by strong friction of the textile upper or cover material 5.

As far as the textile upper or cover material 5 also shown schematically in FIGS. 1A to 1C is concerned, this can be used and/or configured in the form of a leather; synthetic leather; woven fabric; a knitted fabric, in particular a knitted fabric or crocheted fabric; a scrim or a textile composite material, in particular a nonwoven. By this means the surface properties of the textile composite material 1 can be adjusted or predefined individually.

According to the invention, it is however preferred if within the framework of the method according to the invention, the textile upper and/or cover material 5 is used or configured in the form of a woven fabric, knitted fabric or crocheted fabric.

In particular, the textile upper and/or cover material 5 can comprise at least one natural yarn or natural fiber (natural yarn or natural fibers) and/or at least one synthetic yarn or fiber (chemical yarn or chemical fibers) or consist thereof. As a result, the surface properties can be further modified, in particular wherein the yarn or the fibers is or are selected from the group of wool fibers or yarns, cotton fibers or yarns (CO), polyesters (PES); polyolefins, in particular polyethylene (PE) and/or polypropylene (PP); polyvinyl chlorides (CLF); polyvinylidene chlorides (CLF); acetates (CA); triacetates (CTA); polyacrylonitrile (PAN); polyamides (PA); polyvinyl alcohols (PVAL); polyurethanes; polyvinyl esters; (meth)acrylates; as well as mixtures thereof.

For further details in particular relating to the concept of textile fibers—synonymously also designated as textile fibrous materials—reference can be made for example to Römpp Chemielexikon, Georg Thieme Verlag Stuttgart/New York, Vol 6, 1999, pages 4477 to 4479, key word: “textile fibers”, the entire disclosure content of which including the literature passages mentioned there is herewith included by reference. In particular within the framework of the present invention the concept of textile fibers is understood as a collective designation for all fibers which can be processed as textiles. Textile fibers have in common a large length compared to their cross-section as well as sufficient strength and resilience, wherein the textile fibers can be divided into different groups according to origin and material condition. In particular, the fibers provided generally within the framework of the present invention can be used in the form of (textile) threads.

It is furthermore possible to proceed according to the invention in such a manner that the textile upper and/or cover material 5 and/or the textile carrier layer 2, independently of one another, preferably the textile carrier layer 2, in particular in at least one direction of extension of the textile upper and/or cover material 5 and/or the textile carrier layer 2, are configured to be elastic and/or in particular reversibly stretchable. In this context, the respective elasticity and/or the in particular reversible stretchability, likewise independently of one another, can be 0.5% to 30%, in particular 1% to 20%, preferably 1.5% to 10%, relative to the respective direction of extension in the non-stretched state.

For this purpose it can be provided within the framework of the procedure according to the invention to proceed in such a manner that the textile upper and/or cover material 5 and/or the textile carrier layer 2, independently of one another, preferably the textile carrier layer 2, comprise at least one elastic yarn or elastic thread or are equipped therewith. In this respect, reference can also be made to the following explanations.

According to an alternative embodiment of the present invention, it can however also be provided that in particular the textile upper and/or cover material 5 and/or the textile carrier layer 2, preferably the textile upper and/or cover material 5, is at least substantially not stretchable or at least substantially not elastic or is configured to be at least substantially not elastic. Accordingly it can thus be provided according to the invention that textile upper and/or cover material 5 has no elastic yarn or no elastic fibers.

As far as the configuration of the textile composite material 1 according to the invention is further concerned, the textile carrier layer 2 and/or the textile upper and/or cover material 5 and/or the textile sliding and/or protective material 4, independently of one another, can be configured in such a manner and/or arranged in such a manner in the textile composite material 1 that the textile carrier layer 2 and/or the textile upper and/or cover material 5 and/or the textile sliding and/or protective material 4 on the one hand overlap and/or project beyond the foam-based surface material 3 on the other hand at least in sections at the edge (i.e. for example are configured to be larger in surface area and thus extend over the edge of the corresponding layers) and/or that the textile carrier layer 2 and/or the textile upper and/or cover material 5 and/or the textile sliding and/or protective material 4 on the one hand extend beyond the edge of the foam-based surface material 3 on the other hand. By this means, for example, the fixing or fastening to a carrier or frame device can be adapted accordingly individually.

In particular, it is also possible to proceed within the framework of the present invention in such a manner that the textile carrier layer 2 and/or the foam-based surface material 3 and/or the textile sliding and/or protective material 4 and/or the laminate material 1a on the one hand overlap or project beyond the textile upper and/or cover material 5 on the other hand at least in sections at the edge or that the textile carrier layer 2 and/or the foam-based surface material 3 and/or the textile sliding and/or protective material 4 on the one hand extend beyond the edge of the textile upper and/or cover material 5. By this means in particular account is taken of the generally greater (heat) shrinkage in particular of the textile carrier layer 2 so that in the shrunk state a corresponding adaptation of the area of the textile upper and/or cover material 5 with those of the other layers takes place.

It is thus possible to proceed according to the invention in such a manner that the textile upper and/or cover material 5 is configured to be smaller in terms of surface area than the textile carrier layer 2 and/or the foam-based surface material 3 and/or the textile sliding and/or protective material 4 and/or the laminate material 1a, in particular the textile carrier layer 2.

In particular, in addition to the previously specified joining or adhesive bonding of the respective layers or materials, it can also be provided within the framework of the method according to the invention that the textile composite material 1, in particular the textile carrier layer 2 and/or the textile upper and/or cover material 5 and/or the textile sliding and/or protective material 4 and optionally the foam-based surface material 3 is or are joined, in particular sewn, welded, tacked, clamped and/or adhesively bonded, in particular sewn at the edge and/or at their respective edges, at least in sections. This can on the one hand increase the stability of the composite overall and on the other hand improve the edge-side fastening or fixing on a carrier or frame device.

In this context, it can also be provided that the textile composite material 1 is bordered at least in sections at the edge, in particular by means of a free and/or piping edge (piping) or the like.

In general, the textile composite material 1 at least in sections at the edge can additionally be equipped with or provided with at least one receiving or fastening device, in particular for receiving or fastening a carrier or frame device. This can be accomplished, for example, by whipping or the like in particular of the textile carrier layer 2.

Within the framework of the method according to the invention, it is in particular provided that the foam-based surface material 3, in particular foam layer, the textile sliding and/or protective material 4 and/or the textile upper and/or cover material 5 are configured to be at least substantially not (heat-) shrinkable.

In general, the textile composite material can be provided in the form of a web and/or rolled good. This on the one hand improves transport properties and the subsequent processing or individual assembly, in particular as far as an application-specific tailoring of the composite material 1 is concerned.

A further subject matter of the present invention—according to a second aspect of the present invention—is in addition the textile composite material 1 according to the invention having shrink properties, in particular heat shrink properties, preferably in the form of a shrinkable, in particular heat-shrinkable textile upholstery and/or covering material, preferably for seating furniture, wherein the textile composite material 1 can be obtained by the previously defined method according to the invention.

In this context, the present invention therefore also relates to a textile composite material 1, shown in particular in FIGS. 2A and 2B, having shrink properties, in particular heat shrink properties, preferably in the form of a shrinkable, in particular heat-shrinkable, textile upholstery and/or covering material, preferably for seating furniture, in particular as previously defined, wherein the textile composite material 1 comprises:
at least one shrinkable, in particular heat-shrinkable, textile carrier layer 2;
at least one foam-based surface material 3, in particular foam layer, wherein the foam-based surface material 3 is joined, preferably extensively joined, in particular adhesively bonded by means of at least one binder 6 to the textile carrier layer 2, in particular wherein the joining, preferably extensive joining, in particular adhesive bonding is carried out at a temperature below the shrink temperature, in particular heat shrink temperature of the textile carrier layer 2; and
at least one in particular extensive textile sliding and/or protective material 4, wherein the textile sliding and/or protective material 4 is applied and/or arranged on the side of the foam-based surface material 3 facing away from the textile carrier layer 2.

In this context, it is in particular provided within the framework of the present invention that the textile composite material 1 additionally comprises at least one textile upper and/or cover material 5. In this case, the textile upper and/or cover material 5 can be applied and/or arranged on the side of the textile sliding and/or protective material 4 facing away from the foam-based surface material 3.

In particular, it can be provided according to the invention that the textile carrier layer 2, the foam-based surface material 3 and/or the textile sliding and/or protective material 4 are joined to one another, preferably extensively joined, in particular adhesively bonded, in particular to form and/or provide a laminate material 1a.

According to the invention, an adhesive which forms adhesive bonds and/or adhesive forces below the shrink temperature, in particular heat shrink temperature, of the textile carrier layer 2, can be used as binder 6, in particular adhesive for the textile composite material 1 according to the invention.

In this context, an adhesive which forms adhesive bonds and/or adhesive forces at temperatures of at most 100° C., in particular at most 80° C., preferably at most 60° C., preferably at most 40° C., can be used as binder 6, in particular adhesive.

According to the invention, a thermally stable binder 6, in particular adhesive, in particular at temperatures of up to 100° C., in particular of up to 140° C., preferably of up to 180° C., preferably of up to 200° C., particularly preferably of up to 240° C., can be used as binder 6, in particular adhesive.

In addition, a moisture cross-linking and/or heat cross-linking adhesive, in particular reactive hot melt adhesive, preferably polyurethane-based can be used as binder 6, in particular adhesive.

According to the invention, an adhesive based on at least one polyol, in particular polyester polyol, on the one hand and an isocyanate, in particular diphenylmethane diisocyanate (MDI) and/or toluene diisocyanate (TDI), on the other hand can be used as binder 6, in particular adhesive.

In addition, the binder 6, in particular adhesive, can be used in a quantity, in particular application quantity, in the range of 5 g/m² to 200 g/m², in particular in the range of 10 g/m² to 150 g/m², preferably in the range of 15 g/m² to 100 g/m², preferably in the range of 20 g/m² to 80 g/m².

According to the invention, it can additionally be provided in the composite material 1 according to the invention that the sliding and/or protective material 4 is joined, preferably extensively joined, in particular adhesively bonded to the foam-based surface material 3.

As far as the textile composite material 1 according to the invention is furthermore concerned, furthermore the textile upper and/or cover material 5 can rest on or be applied to the sliding and/or protective material 4 and/or the laminate material 1a at least substantially loosely or to form a loose composite.

In this context however, in general an in particular edge-side fastening of the upper or cover material 5 to the further layers or the laminate material 1a can be provided:

Thus, the textile upper and/or cover material 5 can be joined, in particular sewn, welded, tacked, clamped and/or adhesively bonded, in particular sewn in sections, in particular at the edge, to the sliding and/or protective material 4 and/or the foam-based surface material 3 and/or the textile carrier layer 2 and/or the laminate material 1a. For example, the in particular edge-side join can be made by means of a free and/or piping edge or the like. In principle however, an extensive join of the textile upper and/or cover material 5 to the sliding and/or protective material 4 is possible.

Furthermore, the textile carrier layer 2 of the composite material 1 according to the invention can be configured in the form of a woven fabric; a knitted fabric, in particular a knitted fabric or crocheted fabric; a scrim or a textile composite material, in particular nonwoven. On this matter, reference can also be made for example to FIGS. 3A and 3B.

In particular, the textile carrier layer 2 can be configured in the form of a woven fabric, knitted fabric or crocheted fabric, preferably in the form of a woven fabric.

In particular, the textile carrier layer 2, as shown in FIG. 3A, can be configured in the form of a woven fabric with yarn systems 7, 8 comprising a plurality of weft threads and/or yarns 7 and a plurality of warp threads and/or yarns 8.

In particular, the textile carrier layer 2 can comprise at least one shrinkable, in particular heat-shrinkable plastic yarn.

In this context, as shown in FIG. 3A, the textile carrier layer 2 of the composite material 1 according to the invention can be configured in the form of a woven fabric, wherein the woven fabric additionally comprises (heat) shrink weft threads and/or yarns 7a and/or (heat) shrink warp threads 8a, preferably (heat) shrink weft threads and/or yarns 7a or (heat) shrink warp threads and/or yarns 8a. In this context, the (heat) shrink weft threads and/or yarns 7a and/or the (heat) shrink warp threads and/or yarns 8a, independently of one another, can comprise at least one shrinkable, in particular heat-shrinkable plastic yarn or consist thereof. As a result, the shrink behavior can be further adjusted, in particular also as far as the shrink direction is concerned. Thus, the textile carrier layer 2 can be configured to be (heat-) shrinkable in one direction of extension or in both directions of extension.

In this context, it can in particular be provided according to the invention that in the weft direction of the textile carrier layer 2 configured in particular as a textile woven fabric, every second to tenth weft thread (weft yarn) is a (heat) shrink weft thread or yarn 7a or that in the warp direction of the textile carrier layer 2 configured as a textile woven fabric every second to tenth warp thread (warp yarn) is a (heat) shrink warp thread or yarn 8a.

In particular, the weft threads or yarns 7 and/or the warp threads or yarns 8 and/or the (heat) shrink weft threads or yarns 7a and/or (heat) shrink warp threads or yarns 8a can be spaced apart from the thread and/or yarn which is respectively adjacent and/or arranged substantially parallel thereto by 0.15 times to 2.5 times, in particular by 0.2 times to 2 times, preferably by 0.4 times to 1.4 times, preferably by 0.6 times to 0.9 times the average thread and/or yarn diameter of the respective weft thread and/or yarn 7 and/or warp thread and/or yarn 8 and/or (heat) shrink weft thread and/or yarn 7a and/or (heat) shrink warp thread and/or yarn 8a relative to the non-shrunk textile carrier layer 2. This in particular ensures that the individual yarns do not slide over one another during the shrinking process.

In particular, the textile carrier layer 2 configured as a textile woven fabric in the non-shrunk state can have a fiber and/or yarn density in the weft direction and/or in the warp direction, independently of one another, in the range of 1 to 100 threads/cm or yarns/cm, in particular in the range of 2 to 50 threads/cm or yarns/cm, preferably in the range of 3 to 30 threads/cm or yarns/cm.

In addition, the weft threads or yarns 7 and/or the warp threads or yarns 8, independently of one another, can comprise at least one in particular textile yarn or corresponding fibers which is different from the shrinkable, in particular heat-shrinkable yarn, in particular as defined hereinafter, or consist thereof.

As far as the textile carrier layer 2 is further concerned, this can also be configured in the form of a knitted fabric, in particular a knitted fabric or crocheted fabric, preferably in the form of a knitted fabric. In this context, the knitted fabric, in particular the knitted fabric or crocheted fabric, preferably the knitted fabric, can have a foundation, in particular selected from the group of pillar stitch, stockinet, cloth, satin, velvet and atlas. In this context, the foundation can comprise at least one shrinkable, in particular heat-shrinkable plastic yarn or consist thereof. For this purpose in general reference can also be made to FIG. 3B.

In addition, the knitted fabric, in particular the knitted fabric or crocheted fabric, preferably the knitted fabric as shown in FIG. 3B can comprise at least one binding element 9, in particular selected from the group of weft, inlay, filler thread or yarn, loop and float stitch. At the same time, the knitted fabric or the binding elements as such can comprise at least one in particular textile yarn or corresponding fibers which differs from the shrinkable, in particular heat-shrinkable yarn, in particular as defined hereinafter, or consist thereof.

In addition, the knitted fabric, in particular the knitted fabric or crocheted fabric, preferably the knitted fabric as shown in FIG. 3B, can comprise at least one (heat) shrink binding element 9a, in particular selected from the group of (heat) shrink weft, (heat) shrink inlay, (heat) shrink filler thread or yarn, (heat) shrink loop, and (heat) shrink float stitch, wherein the (heat) shrink binding element in turn can comprise at least one shrinkable, in particular heat-shrinkable plastic yarn or consist thereof.

In general, it can be provided in this case that every second to tenth binding element is configured as (heat) shrink binding element 9a and/or comprises at least one heat-shrinkable plastic yarn or consists thereof.

In particular, the binding elements or the (heat) shrink binding elements 9a can be spaced apart from the respectively adjacent binding element and/or (heat) shrink binding element 9a by 0.1 times to 5 times, in particular by 0.2 times to 4 times, preferably by 0.4 times to 2 times, preferably by 0.5 times to 1 times, the average diameter of the respective binding element and/or (heat) shrink binding element relative to the non-shrunk textile carrier layer 2.

According to the invention, it can be provided in relation to the textile composite material 1 according to the invention that the shrinkable, in particular heat-shrinkable plastic yarn comprises a polyester based in particular on phthalate, preferably polyethylene terephthalate, polypropylene terephthalate, polybutylene terephthalate, preferably polyethylene terephthalate, or consists thereof.

In particular, the textile carrier layer 2 can contain the shrinkable, in particular heat-shrinkable plastic yarn in a quantity in the range of 1.5 wt. % to 55 wt %, in particular in the range of 2 wt % to 40 wt %, preferably in the range of 5 wt. % to 30 wt %, preferably in the range of 6 wt. % to 20 wt. %, particularly preferably in the range of 7 wt. % to 15 wt %, quite particularly preferably in the range of 8 wt. % to 10 wt %, relative to the textile carrier layer 2.

According to the invention, it can likewise be provided that the shrinkable, in particular heat-shrinkable plastic yarn has a shrinkage, in particular heat shrinkage in the range of 2% to 75%, in particular in the range of 5% to 60%, preferably in the range of 10% to 50%, preferably in the range of 15% to 40%, particularly preferably in the range of 20% to 35%, or more than 20%, relative to the length in the non-shrunk state and at a temperature of 140° C. to 240° C., in particular 160° C. to 200° C., preferably about 180° C.

In particular, the shrinkable, in particular heat-shrinkable plastic yarn, can have a shrinkage, in particular heat shrinkage, in the range of 2% to 40%, in particular in the range of 3% to 30%, preferably in the range of 4% to 30%, preferably in the range of 5% to 20%, particularly preferably in the range of 6% to 15%, or more than 10%, relative to the length in the non-shrunk state and at a temperature of 60° C. to 140° C., in particular 80° C. to 120° C., preferably about 100° C.

Within the framework of the present invention, the shrinkable, in particular heat-shrinkable plastic yarn can be configured as monofilament or as multifilament or the shrinkable, in particular heat-shrinkable plastic yarn can be configured as fiber yarn or staple fiber yarn. In this case, the heat-shrinkable staple fiber yarn can comprise a shrinkable, in particular heat-shrinkable plastic yarn and optionally at least one further non-heat-shrinkable yarn. In general according to the invention, the use of suitable shrinkable, in particular heat-shrinkable plastic threads also comes into consideration.

In general, the shrinkable, in particular heat-shrinkable plastic yarn in the non-shrunk state can have a diameter in the range of 0.05 mm to 1 mm, in particular in the range of 0.05 mm to 0.8 mm, preferably in the range of 0.1 mm to 0.6 mm, preferably in the range of 0.15 mm to 0.4 mm, in particular wherein the shrinkable, in particular heat-shrinkable plastic yarn has a titer in the range of 50 dtex to 3000 dtex, in particular in the range of 100 dtex to 2500 dtex, preferably in the range of 200 dtex to 2250 dtex, preferably in the range of 300 dtex to 2000 dtex, particularly preferably in the range of 300 dtex to 1600 dtex.

Likewise, the shrinkable, in particular heat-shrinkable plastic yarn can have a tenacity in the range of 10 cN/tex to 120 cN/tex, in particular in the range of 20 cN/tex to 100 cN/tex, preferably in the range of 30 cN/tex to 80 cN/tex, preferably in the range of 30 cN/tex to 60 cN/tex, at a temperature of 10° C. to 100° C., in particular 10° C. to 50° C., preferably about 20° C. The tenacity can in particular be determined on the basis of DIN 53 816 or DIN 53 834 (Parts 1 to 3).

Finally, the shrinkable, in particular heat-shrinkable plastic yarn can have a breaking elongation in the range of 2% to 50%, in particular in the range of 5% to 40%, preferably in the range of 10% to 30%, preferably in the range of 10% to 20%, at a temperature of 10° C. to 100° C., in particular 10° C. to 50° C., preferably about 20° C., wherein the shrinkable, in particular heat-shrinkable plastic yarn, the heat-shrinkable plastic yarn, has a shrinkage force in the range of 10 cN to 1000 cN, in particular in the range of 20 cN to 900 cN, preferably in the range of 30 cN to 800 cN, preferably in the range of 40 cN to 600 cN, at a temperature of 140° C. to 240° C., in particular 160° C. to 200° C., preferably about 180° C. The breaking elongation can be determined in particular on the basis of ISO 3341:2000-05.

In addition, the shrinkable, in particular heat-shrinkable plastic yarn, can have a shrinkage force in the range of 0.5 cN/tex to 10 cN/tex, in particular in the range of 1 cN/tex to 5 cN/tex, preferably in the range of 1.5 cN/tex to 4 cN/tex, preferably in the range of 2 cN/tex to 3.5 cN/tex, at a temperature of 140° C. to 240° C., in particular 160° C. to 200° C., preferably about 180° C.

The shrinkage force can be determined in particular on the basis of DIN 53 866 (Part 12), in particular for a treatment duration of 20 s during treatment in air and a pre-tensioning force of 1 cN.

According to the invention, it can be provided in particular in the case of the composite material 1 according to the invention that the shrinkable, in particular heat-shrinkable textile carrier layer 2 is configured to be shrinkable or heat-shrinkable in at least one direction of extension, in particular relative to the main extension plane, preferably in both directions of the extension of the material in question. In this context, it can be provided for example that for the case where the textile carrier layer 2 is configured in the form of a woven fabric, only weft threads or yarns or only warp threads or yarns as such are equipped with the heat-shrinkable plastic yarn (shrinkability in one direction of extension) or that both weft threads or yarns and also warp threads or yarns comprise the heat-shrinkable plastic yarn (shrinkability in both directions of extension).

By using a special shrinkable, in particular heat-shrinkable plastic yarn, as defined previously, a defined shrink property and furthermore a high load-bearing capacity of the textile composite material 1 according to the invention is achieved so that it can also withstand high force stresses (e.g. “sitting down” when used as seat surface). As a result of the specific shrink properties of the shrinkable, in particular heat-shrinkable plastic yarn, a shrinking of the textile carrier layer 2 of the textile composite material 1 overall is made possible so that in this way the textile composite material 1 can be spanned on a carrier structure, for example, a carrier or frame device for a chair backrest or for a seat surface, or can be fixed thereon, wherein due to the shrinking process a fold-free covering can be ensured while at the same time providing a high stability.

Shrinkable, in particular heat-shrinkable plastic yarns which can be used according to the invention are generally commercially available, for example, from the company Tejin Ltd., Japan. In this respect, for example, the monofilament type 940R can be used according to the invention.

As far as the textile carrier layer 2 is further concerned, this should comprise at least one yarn or a corresponding thread, which is in particular different from the shrinkable, in particular heat-shrinkable plastic yarn, in particular having a titer in the range of 50 dtex to 10 000 dtex, in particular in the range of 100 dtex to 5000 dtex, preferably in the range of 200 dtex to 3750 dtex, particularly preferably in the range of 300 dtex to 900 dtex, quite particularly preferably in the range of 400 dtex to 800 dtex. By this means the textile properties of the carrier layer 2 can be specifically predefined.

In this context, it can be provided according to the invention that the textile carrier layer 2 comprises at least one yarn or corresponding fibers based on a yarn and/or fiber type, in particular textile yarn and/or fiber, which is in particular different from the shrinkable, in particular heat-shrinkable plastic yarn. In this case, the yarn and/or fiber type can comprise natural fibers or natural yarns, preferably wool fibers or yarns, or cotton fibers or yarns (CO), preferably wool fibers or yarns, and/or chemical fibers or yarns, preferably synthetic fibers or synthetic yarns, in particular selected from the group of polyesters (PES); polyolefins, in particular polyethylene (PE) and/or polypropylene (PP); polyvinyl chloride (CLF); polyvinylidene chloride (CLF); acetate (CA); triacetate (CTA); polyacryl (PAN), polyamide (PA), in particular aromatic, preferably flame-retardant polyamides; polyvinyl alcohol (PVAL); polyurethanes; polyvinyl esters; (meth)acrylates; polylactic acids (PLA); as well as mixtures thereof, preferably polyamide (PA), or consist thereof.

In particular, the textile carrier layer 2 can have a grammage in the range of 10 g/m² to 1000 g/m², in particular in the range of 50 g/m² to 750 g/m², preferably in the range of 100 g/m² to 500 g/m².

As far as the foam-based surface material 3 of the composite material 1 according to the invention is further concerned, it is preferred according to the invention if this is configured in the form of an in particular thermoplastic foam based on polyolefins or polyurethanes, preferably polyurethanes.

In particular, the foam-based surface material 3 can be configured in the form of a closed-pore or closed-cell or however in the form of an open-pore or open-cell foam, preferably in the form of a closed-pore and/or closed-cell foam.

According to the invention it can preferably be provided in this case that the foam-based surface material 3 is configured in the form of an in particular closed-pore and/or closed-cell polyurethane foam.

In general, the foam-based surface material 3 should have a thickness in the range of 0.5 mm to 100 mm, in particular in the range of 1 mm to 80 mm, preferably in the range of 2 mm to 50 mm, preferably in the range of 3 mm to 30 mm, particularly preferably in the range of 5 mm to 20 mm.

Furthermore, it is preferred according to the invention if the foam-based surface material 3 has a bulk density in the range of 1 kg/m³ to 200 kg/m³, in particular in the range of 5 kg/m³ to 150 kg/m³, preferably in the range of 10 kg/m³ to 100 kg/m³, preferably in the range of 15 kg/m³ to 50 kg/m³.

Furthermore, the foam-based surface material 3 should have a tensile strength in the transverse and/or longitudinal direction according to ISO 1926 in the range of 100 kPa to 1500 kPa, in particular in the range of 150 kPa to 1300 kPa, preferably in the range of 175 kPa to 1100 kPa. In this context, the foam-based surface material 3 should have a tensile strength in the transverse and/or longitudinal direction according to ISO 1926 of at least 100 kPa, in particular at least 150 kPa, preferably at least 175 kPa.

In general, the foam-based surface material 3 can have a breaking elongation in the longitudinal or transverse direction in the range of 50% to 350%, in particular in the range of 65% to 325%, preferably in the range of 80% to 300%. The breaking elongation can in particular be determined on the basis of ISO 1926.

As far as the compression hardness in accordance with ISO 844 of the foam-based surface material 3 is concerned, at a compression of 10% this should be at least 1 kPa, in particular at least 5 kPa, preferably at least 10 kPa, at a compression of 25%, at least 15 kPa, in particular at least 20 kPa, preferably at least 25 kPa, at a compression of 50% at least 55 kPa, in particular at least 60 kPa, preferably at least 65 kPa. As far as the compression set in accordance with ISO 1856/C under a loading of 22 hours and a compression of 25% at 23° C. is concerned, the foam-based surface material 3 should have a compression set 0.5 hours after removal of the load of at most 20%, in particular at most 10%, preferably at most 5%, and 24 hours after removal of the load, a value of at most 10%, in particular at most 5%, preferably at most 2%. Finally the foam-based surface material 3 should have μ-value in accordance with ISO 1663 at 0%° relative humidity to 85% relative humidity and 23° C. of 5000 to 20 000, in particular 5500 to 15 000, preferably 6000 to 15 000.

The specific selection of the foam-based surface material 3 results in particular in special upholstery properties in relation to the textile composite material 1, which can be individually set through a specific selection of the previously specified features or which can be tailored with a view to the specific area of application or use (e.g. upholstery hardness or the like). Also in this respect, a high ergonomy or a high sitting comfort are obtained in particular when the textile composite material 1 according to the invention is used in particular for backrests and seat elements for seating furniture or the like.

As far as the textile sliding or protective material 4 of the composite material 1 according to the invention is furthermore concerned, it can be provided according to the invention that this is configured in the form of a woven fabric; a knitted fabric, in particular a knitted fabric or crocheted fabric; a scrim or a textile composite material, in particular a nonwoven. According to the invention, it is however preferred if the textile sliding and/or protective material 4 is configured in the form of a knitted fabric, in particular a knitted fabric or crocheted fabric, preferably in the form of a crocheted fabric, particularly preferably in the form of a circular knitted material.

In particular, the textile sliding and/or protective material 4 can therefore be configured in the form of a circular knitted material. According to the invention, the use of a so-called locknit material also comes into consideration.

In particular, the textile sliding and/or protective material 4 can comprise at least one synthetic yarn (chemical yarn) or corresponding fibers (chemical fibers) or consist thereof, in particular wherein the synthetic yarn (chemical yarn) or the corresponding fibers is or are selected from the group of polyesters (PES); polyolefins, in particular polyethylene (PE) and/or polypropylene (PP); polyvinyl chlorides (CLF); polyvinylidene chlorides (CLF); acetates (CA); triacetates (CTA); polyacrylonitrile (PAN); polyamides (PA); polyvinyl alcohols (PVAL); polyurethanes; polyvinyl esters; (meth)acrylates; as well as mixtures thereof, preferably polyesters (PES).

According to the invention, it can in particular be provided that the textile sliding and/or protective material 4 has a grammage in the range of 10 g/m² to 500 g/m², in particular in the range of 20 g/m² to 400 g/m², preferably in the range of 50 g/m² to 300 g/m².

As far as the textile upper or cover material 5 of the composite material 1 according to the invention is furthermore concerned, this can be configured according to the invention in the form of a leather; synthetic leather; woven fabric; a knitted fabric, in particular a knitted fabric or crocheted fabric; a scrim or a textile composite material, in particular a nonwoven.

In particular, the textile upper and/or cover material 5 can be configured in the form of a woven fabric, knitted fabric or crocheted fabric.

According to the invention, it can in this case be provided that the textile upper and/or cover material 5 comprises at least one natural yarn (natural yarn) or corresponding fibers, and/or at least one synthetic yarn (chemical yarn) or corresponding fibers, or consists thereof, in particular wherein the yarn or the corresponding fibers is or are selected from the group of wool fibers or yarns, cotton fibers or yarns (CO), polyesters (PES); polyolefins, in particular polyethylene (PE) and/or polypropylene (PP); polyvinyl chlorides (CLF); polyvinylidene chlorides (CLF); acetates (CA); triacetates (CTA); polyacrylonitrile (PAN); polyamides (PA); polyvinyl alcohols (PVAL); polyurethanes; polyvinyl esters; (meth)acrylates; as well as mixtures thereof.

In general, the textile upper and/or cover material 5 can have a grammage in the range of 15 g/m² to 1000 g/m², in particular in the range of 30 g/m² to 800 g/m², preferably in the range of 60 g/m² to 400 g/m².

As far as the textile upper or cover material 5 or the textile carrier layer 2, independently of one another, preferably the textile carrier layer 2 are further concerned, in particular in at least one direction of extension of the textile upper and/or cover material 5 and/or the textile carrier layer 2, preferably the textile carrier layer 2, these can be configured to be elastic and/or in particular reversibly stretchable. In this context, the elasticity or the in particular reversible stretchability can be 0.5% to 30%, in particular 1% to 20%, preferably 1.5% to 10%, relative to the respective direction of extension in the non-stretched state.

This ensures on the one hand a good adaptation of the textile upper or cover material 5 in relation to the layers located thereunder, accompanied by a reduction in fold formation. In addition, as a result of the defined elasticity or reversible stretchability, it is ensured that the textile composite material 1 according to the invention is overall returned into its initial position after a force stressing so that a permanent flattening of the material is prevented.

The previously specified elasticity or in particular reversible stretchability can be provided in this case by using elastic yarns:

Thus, it can be provided according to the invention that the textile upper and/or cover material 5 and/or the textile carrier layer 2, independently of one another, preferably the textile carrier layer 2, comprise the at least one elastic yarn (or an elastic thread).

In this context, the elastomer thread or the elastomer yarn can be adhesively twisted with at least one thread or yarn, in particular with two threads or yarns.

According to the invention, it can be provided that the elastic yarn comprises an elastomer yarn, in particular rubber yarn, in particular having a titer of 1 to 10 000 dtex, in particular 1 to 5000 dtex, preferably 5 to 4000 dtex, particularly preferably 10 to 3500 dtex, quite particularly preferably 20 to 2500 dtex, or consists thereof. In this case, the elastomer yarn can be adhesively twisted with at least one thread and/or yarn, in particular with two threads and/or yarns.

According to the invention, it can be provided that the textile upper and/or cover material 5 and/or the textile carrier layer 2, independently of one another, preferably the textile carrier layer 2, comprise the elastic yarn in a quantity in the range of 1 wt % to 20 wt. %, preferably in the range of 2 wt. % to 15 wt %, preferably in the range of 3 wt. % to 8 wt. %, relative to the textile upper and/or cover material 5 and/or the textile carrier layer 2.

For example, the elastic yarn can comprise elastomer or rubber yarns. In general, in this respect elastomer or rubber threads, filaments or the like can be used. Thus, it is preferred according to the invention if the textile upper or cover material 5 and/or the textile carrier layer 2, independently of one another, preferably the textile carrier layer 2, has an elastomeric and/or rubber component (e.g. rubber, rubber, elastomeric polymers etc.), preferably in the form of elastomer or rubber yarns. In general corresponding threads can also be used. In particular, a yarn or thread based on at least one thermoplastic elastomer (TPE) can be used as elastic yarn or as elastic thread. Such TPE yarns or threads generally have in particular slight (heat) shrink properties along with their elastic properties so that these materials are particularly suitable for the textile carrier layer 2.

In general, the elastic yarn can be incorporated for example in the form of warp and/or weft threads or yarns in relation to the textile upper or cover material 5 or the textile carrier layer 2, in particular if the materials in question are configured in the form of a woven fabric. In addition, the elastic yarn can be present in the form of binding elements such as weft, inlay, filler thread or yarn, loop or float stitch, in particular if the material in question is a knitted fabric, in particular a knitted fabric or crocheted fabric.

In general, it is possible to proceed according to the invention in such a manner that the textile upper or cover material 5 and/or the textile carrier layer 2, independently of one another, preferably the textile carrier layer 2, are configured to be elastic or reversibly stretchable in only one direction of extension (for example, by using the elastic yarn only in the form of weft threads or yarns or however only in the form of warp threads or yarns in the case where the materials are configured in the form of a woven fabric). In this connection, it can be provided in relation to the shrinkable, in particular heat-shrinkable textile carrier layer 2, for example, that only that direction of extension of the material is configured to be elastic or reversibly stretchable, which does not have the heat-shrinkable plastic yarn or which is not configured to be shrinkable or heat-shrinkable (for example, configuration only of weft threads or yarns with the elastic yarn and configuration only of warp threads or yarns with the shrinkable, in particular heat-shrinkable yarn in the case where the material is configured as woven fabric). Likewise, it can be provided that the textile carrier layer is configured to be elastic or reversibly stretchable in both directions of extension.

In this context, it can fundamentally also be provided that the textile sliding or protective layer 4 is also configured to be in particular reversibly stretchable, in particular in at least one direction of extension. To this end, reference can be made to the above explanations for the textile carrier layer 2 or the upper or cover material 5 and to the elastic yarn used for this purpose, which apply likewise to the sliding or protective layer 4.

According to an alternative embodiment it can be provided according to the invention that the textile upper and/or cover material 5 and/or the textile carrier layer 2, preferably the textile upper and/or cover material 5 is at least substantially not stretchable or is configured to be at least substantially not elastic.

According to the invention, it can be provided in particular in the textile composite material 1 according to the invention that the textile carrier layer 2 and/or the textile upper or cover material 5 and/or the textile sliding and/or protective material 4, independently of one another, are configured in such a manner or arranged in such a manner in the textile composite material 1 that the textile carrier layer 2 and/or the textile upper and/or cover material 5 and/or the textile sliding and/or protective material 4 on the one hand overlap or project beyond the foam-based surface material 3 on the other hand at least in sections at the edge and/or that the textile carrier layer 2 and/or the textile upper and/or cover material 5 and/or the textile sliding and/or protective material 4 on the one hand extend beyond the edge of the foam-based surface material 3.

According to the invention it can also be provided in the textile composite material 1 according to the invention that the textile upper and/or cover material 5 is configured to be smaller in terms of surface area than the textile carrier layer 2 and/or the foam-based surface material 3 and/or the textile sliding and/or protective material 4 and/or the laminate material 1a.

In particular, the textile carrier layer 2 and/or the foam-based surface material 3 and/or the textile sliding and/or protective material 4 and/or the laminate material 1a on the one hand can overlap or project beyond the textile upper and/or cover material 5 on the other hand at least in sections at the edge. In particular, the textile carrier layer 2 and/or the foam-based surface material 3 and/or the textile sliding and/or protective material 4 on the one hand can extend beyond the edge of the textile upper and/or cover material 5.

Likewise, it can be provided according to the invention that the textile composite material 1, in particular the textile carrier layer 2 and/or the textile upper and/or cover material 5 and/or the textile sliding and/or protective material 4 and optionally the foam-based surface material 3 is or are joined, in particular sewn, welded, tacked, clamped and/or adhesively bonded, in particular sewn at the edge and/or at their respective edges, at least in sections.

In particular, the textile composite material 1 can be bordered at least in sections at the edge, in particular by means of a free or piping edge or the like.

According to the invention, it can additionally be provided that the textile composite material 1 at least in sections at the edge is equipped with at least one receiving and/or fastening device, in particular for receiving and/or fastening a carrier and/or frame element, for example for a backrest or a seat element in the case of seating furniture.

As far as the textile composite material 1 according to the invention is further concerned, it is in particular provided according to the invention that the foam-based surface material 3, in particular foam layer, the textile sliding and/or protective material 4 and/or the textile upper and/or cover material 5, independently of one another, are configured to be at least substantially not (heat-) shrinkable so that the shrinkage of the composite material 1 is crucially caused by the textile carrier layer 2.

According to the invention, it can furthermore be provided that the textile composite material 1, in particular the textile carrier layer 2, is heat-shrunk and specifically in particular after corresponding attachment or fixing to a relevant carrier and/or frame device. In this respect, the heating shrinking can be carried out at temperatures in the range of 60° C. to 200° C., in particular in the range of 80° C. to 150° C., preferably in the range of 90° C. to 140° C., preferably in the range of 105° C. to 125° C. By this means, an in particular fold-free and (self-) tensioning spanning or covering in particular of the carrier or frame device, for example, for use as a backrest or seat element, can be implemented.

Furthermore, the present invention—according to a third aspect of the present invention—accordingly also relates to a (heat-) shrunk textile composite material 1′, preferably in the form of a shrunk, in particular heat-shrunk textile upholstery and/or covering material, preferably for seating furniture, as shown for example in FIG. 4A, wherein the (heat-) shrunk textile composite material 1′ comprises:
at least one shrunk, in particular heat-shrunk textile carrier layer 2′;
at least one foam-based surface material 3′, in particular foam layer, wherein the foam-based surface material 3′ is joined, preferably extensively joined, in particular adhesively bonded by means of at least one binder 6′ to the textile carrier layer 2′, in particular wherein the joining, preferably extensive joining, in particular adhesive bonding is made at a temperature below the shrink temperature, in particular heat shrink temperature of the shrunk, in particular heat-shrunk textile carrier layer 2′; and
at least one in particular extensive textile sliding and/or protective material 4′, wherein the textile sliding and/or protective material 4′ is applied and/or arranged on the side of the foam-based surface material 3′ facing away from the shrunk, in particular heat-shrunk textile carrier layer 2′.

For example, the (heat-) shrunk textile composite material 1′ can be produced or obtained from the previously described non-shrunk or shrinkable, in particular heat-shrinkable textile composite material 1 according to the invention. In this respect, a shrinking or heat treatment can have been carried out on the textile composite material 1 to obtain the (heat-) shrunk textile composite material 1′. The basic heat treatment is selected with regard to the shrinkage conditions in relation to temperature and duration in particular in such a manner that the desired shrinkage of the textile composite material 1′ is obtained. The person skilled in the art is capable at any time of selecting and tuning the corresponding shrinkage conditions, for example in relation to shrink temperature and shrink duration with a view to the desired shrinkage or the shrinkage to be set or the materials used according to the invention. In this context, the (heat-) shrunk textile composite material 1′ can, for example, have been heat shrunk at temperatures in the range of 60° C. to 200° C., in particular in the range of 80° C. to 150° C., preferably in the range of 90° C. to 140° C., preferably in the range of 100° C. to 130° C.

In this respect the shrinkage relates in particular to the textile carrier layer 2′ of the (heat-) shrunk textile composite material 1′.

As far as the (heat-) shrunk textile composite material is concerned in this context, the (heat-) shrunk textile composite material 1′ can comprise at least one textile upper and/or cover material 5′. In this context, the textile upper and/or cover material 5′ can be applied and/or arranged on the side of the textile sliding and/or protective material 4′ facing away from the foam-based surface material 3′.

In particular, the shrunk, in particular heat-shrunk textile carrier layer can be configured in the form of a woven fabric; a knitted fabric, in particular a knitted fabric or crocheted fabric; a scrim or a textile composite material, in particular nonwoven.

According to the invention, it is however preferred if the shrunk, in particular heat-shrunk textile carrier layer 2′ is configured in the form of a woven fabric, knitted fabric or crocheted fabric, preferably in the form of a woven fabric.

In particular, the shrunk, in particular heat-shrunk textile carrier layer 2′ can comprise at least one shrunk, in particular heat-shrunk plastic yarn. In this respect, reference can be made to the above explanations according to the further aspects according to the invention for the shrinkable, in particular heat-shrinkable plastic yarn.

It can furthermore be provided according to the invention that the shrunk, in particular heat-shrunk textile carrier layer 2 is configured in the form of a woven fabric, wherein the woven fabric additionally comprises shrunk, in particular heat-shrunk (heat) shrink weft threads and/or yarns and/or shrunk, in particular heat-shrunk (heat) shrink warp threads and/or yarns, preferably shrunk, in particular heat-shrunk (heat) shrink weft threads and/or yarns or shrunk, in particular heat-shrunk (heat) shrink warp threads and/or yarns. In this case, the (heat) shrink weft threads or yarns and/or the (heat) shrink warp threads or yarns, independently of one another, can comprise at least one shrunk, in particular heat-shrunk plastic yarn or consist thereof.

In particular, the shrunk, in particular heat-shrunk textile carrier layer 2′ can be configured in the form of a knitted fabric, in particular a knitted fabric or crocheted fabric, preferably in the form of a knitted fabric.

In this context, the knitted fabric, in particular the knitted fabric or crocheted fabric, preferably the knitted fabric, can have a foundation, in particular selected from the group of pillar stitch, stockinet, cloth, satin, velvet and atlas. In this case, the foundation can comprise at least one shrunk, in particular heat-shrunk plastic yarn or consist thereof.

In particular, the knitted fabric, in particular the knitted fabric or crocheted fabric, preferably the knitted fabric can comprise at least one binding element, in particular selected from the group of weft, inlay, filler thread or yarn, loop and float stitch.

Preferably the knitted fabric, in particular the knitted fabric or crocheted fabric, preferably the knitted fabric, can additionally comprise at least one shrunk, in particular heat-shrunk (heat) shrink binding element, in particular selected from the group of (heat) shrink weft, (heat) shrink inlay, (heat) shrink filler thread or yarn, (heat) shrink loop, and (heat) shrink float stitch, wherein the shrunk, in particular heat-shrunk (heat) shrink binding element comprises at least one shrunk, in particular heat-shrunk plastic yarn or consists thereof.

For further explanations for the further components or materials of the (heat-) shrunk textile composite material 1′ according to the invention, in particular for the textile carrier layer 2′, the foam-based surface material 3′, the binder 6′ used, the extensive textile sliding or protective material 4′ and the textile upper or cover material 5′, reference can be made to the above explanations for the shrinkable, in particular heat-shrinkable textile composite material 1 according to the invention and for the method according to the invention with the corresponding explanations for the corresponding layers or materials 2, 3, 4, 5, and 6, which apply accordingly.

As far as the (heat-) shrunk textile composite material 1′ according to the invention is further concerned, it can in particular be provided that the (heat-) shrunk textile composite material 1′, preferably the shrunk, in particular heat-shrunk textile carrier layer 2′, is shrunk by 1% to 50%, in particular 2% to 40%, preferably 3% to 30%, preferably 4% to 20%, particularly preferably 5% to 15%, quite particularly preferably 5% to 10%, relative to the respective direction of extension and/or relative to the length and/or width in the non-shrunk state (and therefore in particular of the textile composite material 1 and/or the textile carrier layer 2).

With regard to the (heat-) shrunk textile composite material 1′ according to the invention, a compaction in particular of the shrunk, in particular heat-shrunk textile carrier layer 2′ can in particular also be provided (in particular by thickening the (heat-) shrunk plastic yarn and reducing the yarn spacing). In this context, for example in relation to the formation of the textile carrier layer 2′ in the form of a shrunk woven fabric, the respective weft threads or yarns or warp threads or yarns can have a reduced distance compared to the non-shrunk state with respect to the respectively adjacent thread or yarn.

The binder 6′, in particular adhesive, is a thermally stable binder, in particular adhesive, in particular at temperatures of up to 100° C., in particular of up to 140° C., preferably of up to 180° C., preferably of up to 200° C., particularly preferably of up to 240° C. This prevents a delamination during the preceding heat shrinking.

According to the invention, the shrunk, in particular heat-shrunk textile carrier layer 2′, in particular in the form of a woven fabric, can have a sliding resistance, in particular seam sliding resistance, in particular in each case relative to the warp direction or weft direction and according to DIN 53868, of at least 60 N, in particular at least 110 N, preferably at least 160 N, preferably at least 210 N, particularly preferably at least 310 N.

In particular, the shrunk, in particular heat-shrunk textile carrier layer 2′, in particular in the form of a woven fabric can have a tensile strength, preferably in each case relative to the warp direction and/or weft direction and according to EN ISO 13934-1, of at least 310 N, in particular at least 410 N, preferably at least 610 N, preferably at least 810 N.

In addition, the shrunk, in particular heat-shrunk textile carrier layer 2′, in particular in the form of a woven fabric, can have a tear resistance, in particular relative to the weft direction and according to EN ISO 13937-3, of at least 355 N, in particular at least 45 N, preferably at least 65 N, preferably at least 85 N.

As a result, high force stresses can be implemented in cases of usage or application, for example, if the (heat-) shrunk textile composite material 1′ is employed for use in a backrest or a seat part or seat element.

Overall the (heat-) shrunk textile composite material 1′ thus also has exceptional properties so that it is in particular also suitable for applications in which high force loads or stresses occur, for example, in the furniture industry in the area of seating furniture or the like.

A further subject matter of the present invention—according to a fourth aspect of the present invention—is the use of the textile composite material 1 having shrink properties, in particular heat shrink properties as defined previously to produce or manufacture the previously defined (heat-) shrunk textile composite material 1′ according to the invention.

In this context, in order to obtain the (heat-) shrunk textile composite material 1′ according to the invention, the non-shrunk textile composite material 1 according to the invention can be heat shrunk under the already-described (heat) shrink conditions, preferably after attachment (spanning) or fastening to or on a carrier or frame device.

A further subject matter of the present invention—according to a fifth aspect of the present invention—is in addition the method according to the invention for producing the (heat-) shrunk textile composite material 1′ according to the invention as defined previously, wherein a textile composite material 1 according to the invention, as defined previously, having shrink properties, in particular heat shrink properties is shrunk by means of heat treatment. With regard to further explanations relating to the heat treatment to be carried out, reference can be made to the above explanations, which apply accordingly.

The present invention further relates—according to a sixth aspect of the present invention—to the use of the textile composite material 1 according to the invention having shrink properties, in particular heat shrink properties as defined previously, or of the (heat-) shrunk textile composite material 1′ according to the invention, as defined previously, in the area of the furniture industry, automobile industry and the like.

In general, the textile composite material 1 or 1′ according to the invention can be used for the purposes of interior design also as interior or as interior components and for the purposes of exterior design to a certain extent as exterior or exterior components. For example, the textile composite material 1 or 1′ according to the invention is suitable for producing or use as covering material or upholstery of carrier or frame devices or structures such as support frames of in particular seating furniture or the like.

In this context, the present invention—according to a seventh aspect of the present invention—also relates to the use of the textile composite material 1 according to the invention having shrink properties, in particular heat shrink properties as defined previously, or of the (heat-) shrunk textile composite material 1′ according to the invention, as defined previously, to produce furniture elements, in particular seating furniture elements, preferably backrests and/or seat parts, decorative elements, cavity channels, automobile accessories, and the like.

In this context, the term “seating furniture” according to the invention is to be understood very broadly: the term “seating furniture” thus covers in particular seating devices or seat elements of all kinds, such as for example chairs, deckchairs, couches, armchairs, sofas, benches, couch accessories, stools and the like, wherein the seating furniture can in particular be of the design such that it has the textile composite material 1 or 1′ according to the invention in particular in the form of a covering with upholstery properties.

In this context, one concept of the present invention consists in particular in that firstly the shrinkable, in particular heat-shrinkable textile composite material 1 according to the invention in the non-shrunk state is fixed or attached or spanned on or onto a carrier or frame structure, wherein the carrier is in particular arranged at the edge regions of the textile composite material according to the invention, wherein the textile composite material according to the invention can be fastened or fixed at its edges on the carrier or frame device. The carrier or frame device in question can in particular be a frame or the like, as is used in particular for seating furniture to form a (back)rest and/or a seat surface. In this context, it can be provided according to the invention that the carrier or frame is configured in such a manner that the textile composite material according to the invention is fixed at all the edges on the carrier. Likewise however it is also within the framework of the present invention if for example only the respectively opposite edges of the textile composite material according to the invention are fastened to the carrier or frame device. As a result of the (heat) shrinkage provided according to the invention, the textile composite material according to the invention is so to speak spanned onto or on the carrier or frame device, wherein any folds, bulging or the like are so to speak smoothed by the resulting shrink forces.

A further subject matter of the present invention—according to an eighth aspect of the present invention—is in addition the method according to the invention for producing furniture elements, in particular seating furniture elements, preferably backrests and/or seat elements, decorative elements, cavity channels, automobile accessories, and the like, wherein a textile composite material 1 having shrink properties, in particular heat shrink properties as defined previously is attached or fixed and/or in particular fastened at the edge to a carrier or frame device and subsequently the textile composite material 1 is heat shrunk to obtain the (heat-) shrunk textile composite material 1′ as defined previously. In this context, in particular an at least substantially fold-free and preferably (self-) tensioned and/or reversibly stretchable covering of the carrier structure with the (heat-) shrunk textile composite material 1′ is obtained.

Finally the present invention also relates—according to a ninth aspect of the present invention—to furniture elements, in particular seating furniture elements, preferably backrests and/or seat parts or seat elements, decorative elements, cavity channels, automobile accessories, and the like, comprising at least one textile composite material 1 according to the invention having shrink properties, in particular heat shrink properties as defined previously or comprising at least one (heat-) shrunk textile composite material 1′ according to the invention as defined previously. According to the invention, overall a high-performance and flexibly adaptable concept is thus provided within the framework of a shrinkable, in particular heat-shrinkable textile composite material, which as a result of its variability and flexibility is suitable for numerous applications, as described previously.

Further configurations, modifications, variations, modifications, particular features and advantages of the present invention can readily be identified and implemented for the person skilled in the art upon reading the description without departing from the framework of the present invention.

### REFERENCE LIST

1 Textile composite material having shrink properties, in particular heat shrink properties
1′ (Heat-) shrunk textile composite material
1a Laminate material
2 Shrinkable, in particular heat-shrinkable textile carrier layer
2′ Shrunk, in particular heat-shrunk textile carrier layer
3 Foam-based surface material
3′ Foam-based surface material of the (heat-) shrunk textile composite material
4 Textile sliding and/or protective material
4′ Textile sliding and/or protective material of the (heat-) shrunk textile composite material
5 Textile upper and/or cover material
5′ Textile upper and/or cover material of the (heat-) shrunk textile composite material
6 Binder
6′ Binder of the (heat-) shrunk textile composite material
7 Weft thread or yarn of the textile carrier layer
7a (Heat) shrink weft thread or yarn of the textile carrier layer
8 Warp thread or yarn of the textile carrier layer
8a (Heat) shrink warp thread or yarn of the textile carrier layer
9 Binding element of the textile carrier layer
9a (Heat) shrink binding element of the textile carrier layer

1-15. (canceled)

16. A method for producing a textile composite material having heat shrink properties, wherein the textile composite material is in the form of a heat-shrinkable textile upholstery or covering material for seating furniture,
wherein a heat-shrinkable textile carrier layer is joined, by adhesive bonding, to at least one foam-based surface material, using at least one adhesive, at a temperature below the heat shrink temperature of the textile carrier layer and
wherein the foam-based surface material is provided, on the side facing away from the textile carrier layer, with at least one textile sliding or protective material.

17. The method as claimed in claim 16,
wherein at least one textile upper or cover material is applied to the sliding or protective material on the side of the textile sliding or protective material facing away from the foam-based surface material.

18. The method as claimed in claim 16,
wherein, firstly, the textile carrier layer, the foam-based surface material and the textile sliding or protective material are joined to one another, by adhesive bonding, to form a laminate material, followed by providing at least one textile upper or cover material to said laminate material on the side of the textile sliding or protective material facing away from the foam-based surface material, to finally obtain the textile composite material.

19. The method as claimed in claim 16,
wherein, firstly, the foam-based surface material and the textile sliding or protective material are joined to one another and then the foam-based surface material provided with the sliding or protective material is joined to the textile carrier material on the side facing away from the sliding or protective material.

20. The method as claimed in claim 16,
wherein, with respect to the adhesive to be used in the method, at least one of the following features (i) to (v) apply:
(i) the adhesive is an adhesive which forms adhesive bonds or adhesive forces below the heat shrink temperature of the textile carrier layer;
(ii) the adhesive forms adhesive bonds or adhesive forces at temperatures of at most 100° C.;
(iii) the adhesive is used in a quantity in the range of from 5 g/m² to 200 g/m² and is applied to at least one of the foam-based surface material and the textile carrier layer;
(iv) the adhesive is applied continuously or discontinuously to at least one of the foam-based surface material and the textile carrier layer;
(v) the adhesive is applied for joining the sliding or protective material to the foam-based surface material.

21. The method as claimed in claim 16,
wherein, with respect to the carrier layer, the foam-based surface material and the sliding or protective material to be used in the method, at least one of the following features (i) to (vi) apply:
(i) the textile carrier layer is used and configured in the form of a woven fabric, a knitted fabric, a crocheted fabric, a scrim, a textile composite material or a nonwoven;
(ii) the textile carrier layer comprises at least one heat-shrinkable plastic yarn, wherein the heat-shrinkable plastic yarn comprises a polyester based on a phthalate;
(iii) the textile carrier layer comprises at least one heat-shrinkable plastic yarn in a quantity in the range of from 1.5 wt % to 55 wt %, relative to the textile carrier layer;
(iv) the textile carrier layer comprises at least one heat-shrinkable plastic yarn, wherein the heat-shrinkable plastic yarn has a heat shrinkage in the range of 2% to 75%, relative to the length in the non-shrunk state and at a temperature of 140° C. to 240° C.;
(v) the foam-based surface material is used and configured in the form of a thermoplastic foam based on polyolefins or polyurethanes;
(vi) the textile sliding or protective material is used and configured in the form of a woven fabric, a knitted fabric, a crocheted fabric, a scrim, a textile composite material or a nonwoven.

22. A textile composite material having heat shrink properties, with the textile composite material being in the form of a heat-shrinkable textile upholstery or covering material for seating furniture,
wherein the textile composite material comprises:
at least one heat-shrinkable textile carrier layer;
at least one foam-based surface material, wherein the foam-based surface material is joined, by adhesive bonding by means of at least one adhesive, to the textile carrier layer, wherein the adhesive bonding is carried out at a temperature below the heat shrink temperature of the textile carrier layer; and
at least one textile sliding or protective material, wherein the textile sliding or protective material is applied and arranged on the side of the foam-based surface material facing away from the textile carrier layer.

23. The textile composite material as claimed in claim 22,
wherein the textile composite material further comprises at least one textile upper or cover material, wherein the textile upper or cover material is applied on the side of the textile sliding or protective material facing away from the foam-based surface material.

24. The textile composite material as claimed in claim 22,
wherein the textile carrier layer, the foam-based surface material and the textile sliding or protective material are joined to one another, by adhesive bonding, to form a laminate material.

25. The textile composite material as claimed in claim 22,
wherein an adhesive which forms adhesive bonds or adhesive forces below the heat shrink temperature of the textile carrier layer is used as binder.

26. The textile composite material as claimed in claim 22,
wherein an adhesive which forms adhesive bonds or adhesive forces at temperatures of at most 100° C. is used as binder.

27. The textile composite material as claimed in claim 22,
wherein the textile carrier layer is configured in the form of a woven fabric, a knitted fabric, a crocheted fabric, a scrim, a textile composite material or a nonwoven.

28. The textile composite material as claimed in claim 22,
wherein the textile carrier layer comprises at least one heat-shrinkable plastic yarn.

29. The textile composite material as claimed in claim 22,
wherein the textile carrier layer comprises at least one heat-shrinkable plastic yarn, wherein the heat-shrinkable plastic yarn comprises a polyester based on a phthalate and wherein the textile carrier layer comprises the heat-shrinkable plastic yarn in a quantity in the range of from 1.5 wt. % to 55 wt. %, relative to the textile carrier layer.

30. The textile composite material as claimed in claim 22,
wherein the foam-based surface material is configured in the form of a thermoplastic foam based on polyolefins or polyurethanes and wherein the textile sliding or protective material is configured in the form of a woven fabric, a knitted fabric, a crocheted fabric, a scrim, a textile composite material or a nonwoven.

31. A heat-shrunk textile composite material in the form of a heat-shrunk textile upholstery or covering material for seating furniture,
wherein the heat-shrunk textile composite material comprises:
at least one heat-shrunk textile carrier layer;
at least one foam-based surface material, wherein the foam-based surface material is joined, by adhesive bonding by means of at least one adhesive, to the textile carrier layer, wherein adhesive bonding is made at a temperature below the heat shrink temperature of the heat-shrunk textile carrier layer; and
at least one textile sliding or protective material, wherein the textile sliding or protective material is applied and arranged on the side of the foam-based surface material facing away from the heat-shrunk textile carrier layer.

32. The heat-shrunk textile composite material as claimed in claim 31,
wherein the heat-shrunk textile composite material is obtained by heat shrinking of the heat-shrinkable textile composite material as defined in claim 22.

33. The heat-shrunk textile composite material as claimed in claim 31
wherein the heat-shrunk textile composite material further comprises at least one textile upper or cover material, wherein the textile upper or cover material is applied and arranged on the side of the textile sliding or protective material facing away from the foam-based surface material, and
wherein the heat-shrunk textile composite material is shrunk by 1% to 50%, relative to the respective direction of extension in the non-shrunk state
